(19) United States
(12) Patent Application Publication
(10) Pub. No.: US 2023/0148588 A1
(43) Pub. Date: May 18, 2023

(54) METHODS, COMPOSITIONS, AND SYSTEMS FOR ENHANCING EX-VIVO ORGAN PERFUSION

(71) Applicant: University Health Network, Toronto (CA)

(72) Inventors: Mingyao LIU, North York (CA); Shafique KESHAVJEE, Toronto (CA)

(73) Assignee: University Health Network, Toronto, ON (CA)

(21) Appl. No.: 17/915,086

(22) PCT Filed: Mar. 26, 2021
(86) PCT No.: PCT/IB2021/052546

§ 371 Date: Sep. 27, 2022

Related U.S. Application Data
(60) Provisional application No. 63/001,304, filed on Mar. 28, 2020.

(51) Int. Cl. A01N 1/02

(52) U.S. Cl. CPC A01N 1/0226; A01N 1/0247

(57) ABSTRACT

An organ perfusion solution includes a colloid component, a salt mixture, a buffer system, and a glutamine compound in a physiologically acceptable medium.

### CROSS REFERENCE TO RELATED APPLICATIONS

This application is a national stage application under 35 USC § 371 of International Application No. PCT/IB2021/052546, filed Mar. 26, 2021, which claims priority to and the benefit of U.S. Provisional Application No. 63/001,304, filed Mar. 28, 2020, the entire contents of which are incorporated herein by reference.

### FIELD

The present disclosure relates to an improved organ perfusion solution and methods for preserving organs ex-vivo.

### BACKGROUND

Lung transplantation represents the only curative intervention for end-stage lung disease. The first successful long-term survival lung transplant was performed in Toronto in 1983; since then, lung transplantation has become a standard treatment for patients with end-stage lung disease. However, lungs are vulnerable to donor-associated injury (e.g., brain death, major trauma, cardiac arrest), and as a result, most donor lungs are deemed unsuitable for transplant. The demand for donor lungs far exceeds the limited global supply, resulting in a 20% mortality rate for patients on lengthy transplant wait lists. Those who do receive a lung transplant are susceptible to the development of primary graft dysfunction (PGD) and chronic lung allograft dysfunction—negative outcomes that contribute to a 5-year survival of only ˜50%. These conditions arise from the transplant of injured or non-optimal donor lungs, and thus create an urgency to increase the number and quality of lung transplantation, reduce deaths on the transplant wait list, and increase the post-transplant survival of transplant recipients.

The development and clinical application of Ex vivo lung perfusion (EVLP) represents a dramatic leap forward in addressing these needs. EVLP is a state-of-the-art technology that maintains donor lungs at 37° C. through mechanical ventilation and the use of a circulating perfusate solution that can restore lung metabolism and enable functional assessment of the lung prior to transplantation (FIG. 1A).

EVLP technology provides an opportunity to apply novel therapies ex vivo to repair injured lungs and, ultimately, rescue more lungs for transplant. EVLP-enabled donor lung repair therapies currently under investigation include the infusion of an adenosine-agonist, addition of steroids, inhalation of therapeutic gases (NO, CO, H2) through ventilation, intra-bronchial administration of surfactant, IL-10 gene delivery, and instillation of mesenchymal stromal cells. EVLP has also enabled the study of high-dose anti-microbial treatment of infection and fibrinolytic agents in the treatment of lungs with major pulmonary embolism, resulting in successful transplantation.

### SUMMARY

According to a first aspect, an organ perfusion solution includes: a colloid component, a salt mixture, a buffer system, and a glutamine compound in a physiologically acceptable medium.

Another aspect of the invention includes an organ perfusion kit that includes a container comprising a glutamine compound; a container comprising an organ perfusion solution, the organ perfusion solution comprising a colloid component and a salt mixture in a physiologically acceptable medium.

Another aspect includes an organ perfusion system that includes an organ perfusion device the organ perfusion device comprising an inlet for connecting to the organ via an input vessel of the organ, (e.g., pulmonary artery, PA) an outlet for connection to the organ via an output vessel of the organ, (e.g., left atrium, LA) a perfusion circuit comprising: a reservoir for holding organ perfusion solution: a waste receptacle; and a plurality of fluid conduits defining a delivery fluid path connecting the reservoir with the inlet (into the PA); a return fluid path independent of the delivery fluid path connecting the outlet with the reservoir (from LA); a dialysis fluid diversion path; and a dialysis fluid return path; and an integrated continuous fluid dialysis machine, the dialysis machine comprising a dialyzer unit, the dialyzer unit having a dialysate container for holding dialysate, a waste container for holding waste dialysate, a dialyzer with: a perfusion import port for receiving fluid to be dialyzed and for connecting to the conduit defining the fluid diversion path, a perfusion export port for returning fluid that has been dialyzed and for connecting to the conduit defining the fluid return path to the export port of the dialyzer, a dialysate import port fluidly connected to the dialysate container; and a dialysate export port fluidly connected to the waste container; and a dialysis filter cartridge; wherein the organ perfusion device is configured to permit a flow rate of about to 3 L/minute and the dialysis machine is configured to permit a flow rate of about 150-250 milliliters/hour, optionally about 200 milliliters/hour.

Another aspect includes a method for machine perfusion of an organ that includes circulating an organ perfusion solution through the organ using an organ perfusion device; and continuously dialyzing a portion of the circulating organ perfusion solution with a dialysate using an integrated dialysis machine.

Optionally, the perfusion and/or the dialysis is performed for at least 4 hours, or at least 8 hrs.

Also provided in another aspect is a method for delivery of a therapeutic agent to an ex vivo organ for transplant comprising: obtaining the organ, the organ having preferably been flushed with a non-blood physiologic solution; introducing the organ into an organ perfusion device and integrated dialysis machine, the organ perfusion device comprising a reservoir comprising organ perfusion solution, the dialysis machine comprising a dialysate container comprising organ dialysate, the organ perfusion solution and optionally the organ dialysate comprising the therapeutic agent; circulating the organ perfusion solution comprising the therapeutic agent through the organ using the organ perfusion device; and dialyzing a portion of the organ perfusion solution as it circulates through the organ using the integrated dialysis machine.

Other features and advantages of the present disclosure will become apparent from the following detailed description. It should be understood, however, that the detailed description and the specific examples, while indicating preferred embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

Embodiments are described in relation to the drawings in which:

FIGS. 1A and 1B depict an EVLP system, according to various embodiments.

FIG. 2A depicts human lung EVLP perfusates that were collected and processed for metabolomics. FIG. 2B is a heatmap showing the global differential metabolite levels at 1 hour and 4 hours of EVLP. FIG. 2C illustrates the metabolites most significantly changed.

FIGS. 3A-C illustrates that in 4 h-human lung EVLP perfusate, metabolomics study shows: Glycolysis substrates glucose, mannose and fructose significantly decreased (FIG. 3A), accumulation of pyruvate and lactate (FIG. 3B) and elevated TCA cycle intermediates except for succinate (FIG. 3C).

FIGS. 4A and 4B depict changes of metabolites at 4 hour human EVLP. Metabolomics data show accumulation of pyrimidine degradation (FIG. 4A) and RNA degradation products (FIG. 4B).

FIG. 5A depicts Steen solution reduced cell confluence, promoted apoptosis and reduced migration of human pulmonary microvascular endothelial cells (HPMEC) and human lung epithelial (BEAS2B) cells, in comparison with cell culture medium, DMEM or DMEM+10% fetal bovine serum (FBS). FIG. 5B shows that adding GlutaMax (grey lines) to Steen solution (black lines) reduced apoptosis and improved cell migration.

FIG. 6 depicts a cell culture model to simulate EVLP process.

FIGS. 7A and 7B illustrate that adding Glutamax to Steen solution reduced apoptosis after either 6 h or 18 h cold ischemic preservation, in both human lung epithelial (BEASE-2B) and endothelial (HPMEC) cells.

FIG. 8 depicts graphs of GlutaMAX inhibited IL-8 production in prolonged CIT (18 h) and simulated EVLP (12 h).

FIGS. 9A-H are graphs of GlutaMAX enhanced Total GSH production in both BEAS-2B and HPMEC at CIT 6 h and EVLP 4 h.

FIGS. 10A-D are graphs of GlutaMAX enhanced HSP70 production in both BEAS-2B and HPMEC at CIT 6 h and EVLP 4 h.

FIGS. 11A-C depicts images from a study showing that adding GlutaMax into perfusate extended EVLP to 36 h. FIG. 11A depicts the appearance of the lung at different time period of EVLP. FIG. 11B depicts H&E staining. FIG. 11C depicts TUNEL staining over the course of the experiment, with the percent of TUNEL positive cells in each section shown on the right.

FIGS. 12A-C depict line graphs of adding GlutaMax into perfusate improved lung function. Results from the first 18 h are summarized. GlutaMax keeps delta PO2 and dynamic compliance higher, and peak airway pressure lower. Grey: GlutaMax Group, Black: historical control.

FIGS. 13A-D depicts line graphs that represent accumulation of electrolytes. FIG. 13E is a line graph that represents accumulation of lactate, and FIG. 13F is a line graph representing drop in pH (F) in perfusate samples during 24 h-pig lung EVLP.

FIG. 14 depicts an EVLP with dialysis system, according to various embodiments.

FIGS. 15A-B depict results of a successful 36 h EVLP using Toronto EVLP+hemodialysis system. FIG. 15A depicts macroscopic appearance of the extracorporeal lung at different time periods throughout perfusate dialysis procedure. FIG. 15B depicts bronchoscopy of large airway at the end of 36 h EVLP.

FIGS. 16A-D depict line graphs of preliminary data for an EVLP+hemodialysis system as compared to historical controls. FIG. 16A shows prevented accumulation of electrolytes in EVLP perfusate compared to historical controls, FIG. 16B shows prevented increase in lactate, drop of glucose, pH and delta PO2, and FIG. 16C shows maintained higher dynamic compliance and stable delta pO2 and Pulmonary vascular resistance (PVR). 100% of dialysis cases were able to proceed to 24 hours compared to only 20% of historical controls as shown in FIG. 16D.

FIG. 17 depicts a schematic of an experimental design and sample collection during the experimentation for an EVLP+dialysis process.

FIGS. 18A-E depict line graphs of dialysis prevented accumulation of pro-inflammatory cytokines, IL-6 (FIG. 18A), IL-8 (FIG. 18B) and IL-1β (FIG. 18C), and removal of ET-1 from perfusate (FIG. 18D) to dialysate (FIG. 18E). Gray lines: EVLP+dialysis; Black: historical control from a recent study.

### DETAILED DESCRIPTION

All publications, patent applications, patents, and other references mentioned herein are incorporated by reference in their entirety. In the case of conflict, the present specification, including definitions, will control. In addition, the materials, methods, and examples are illustrative only and not intended to be limiting.

Unless otherwise defined, scientific and technical terms used in connection with the present disclosure shall have the meanings that are commonly understood by those of ordinary skill in the art. However, it should be understood that other meanings that are known or understood by those having ordinary skill in the art are also possible, and within the scope of the present disclosure. Further, unless otherwise required by context, singular terms shall include pluralities and plural terms shall include the singular. For example, the term “a cell” includes a single cell as well as a plurality or population of cells. Generally, nomenclatures utilized in connection with, and techniques of, cell and tissue culture, molecular biology, and protein and oligonucleotide or polynucleotide chemistry and hybridization described herein are those well-known and commonly used in the art (see, e.g. Green and Sambrook, 2012).

Further, the definitions and embodiments described in particular sections are intended to be applicable to other embodiments herein described for which they are suitable as would be understood by a person skilled in the art. For example, in the following passages, different aspects of the disclosure are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

As used in this specification and the appended claims, the singular forms “a”, “an” and “the” include plural references unless the content clearly dictates otherwise. Thus for example, a composition containing “a compound” includes a mixture of two or more compounds. It should also be noted that the term “or” is generally employed in its sense including “and/or” unless the content clearly dictates otherwise. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of.”

The phrase “at least one” when used herein in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this application and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about”.

The terms “about”, “substantially” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

The term “glutamine compound” as used herein means L-glutamine and stabilized versions thereof such as L-alanyl-Lglutamine dipeptide sold for example as GlutaMAX™ supplement by ThermoFisher Scientific. L-Glutamine Solution (Stabilized) by Gemini Bio and other, as well as compounds that provide an accessible source of L-glutamine when in solution such as when dissolved in organ perfusion solution.

The term “dialysis machine” as used herein is for example any organ dialysis machine. In the present systems and methods, the dialysis machine is configured perform dialysis of the organ perfusion solution and is integrated into the perfusion loop assembly of the organ perfusion device. The dialysis machine includes a dialyzer (e.g., filter, high-flux or low-flux filter), which comprises hollow membrane fibers. The dialyzer has an organ perfusion fluid inlet and an organ perfusion solution outlet. The organ perfusion fluid and dialysate are separated for example by hollow fiber membranes, through these membranes, mass transfer (e.g., by diffusion) and also fluid transfer (e.g., by convection) takes place between dialysate and organ perfusion solution according to concentration and pressure gradients across the membrane. The dialysis machine is for example removing molecules from the organ perfusion solution and/or equilibrating the organ perfusion solution with the dialysate solution through the membrane with respect to glucose, electrolytes, pH-value etc.

It should also be understood that, in certain methods described herein that include more than one step or act, the order of the steps or acts of the method is not necessarily limited to the order in which the steps or acts of the method are recited unless the context indicates otherwise.

Although any methods and materials similar or equivalent to those described herein can also be used in the practice or testing of the present disclosure, examples of methods and materials are now described.

### I. Compositions and Kits

As demonstrated herein, addition of a glutamine compound to a conventional perfusion solution greatly extended the quality and perfusion time and organ can be subjected to ex vivo perfusion (EVP). As shown in the Examples, lungs subjected to extended EVLP using STEEN solution comprising a glutamine compound maintained healthy pulmonary function.

Accordingly, an aspect of the invention includes an organ perfusion solution comprising: a colloid component, a salt mixture, a buffer system, and a glutamine compound in a physiologically acceptable medium.

The glutamine compound can be or include various compounds. In one embodiment, the glutamine compound is a stabilized glutamine compound. In another embodiment, the stabilized glutamine compound is a dipeptide comprising glutamine, for example L-alanyl-L-glutamine. L-alanyl-L-glutamine is sold for example as GlutaMAX™ Supplement.

The concentration of the glutamine compound can for example range from between 0.5 mM and 20 mM, preferably around 4 mM. In some embodiments, the minimum concentration of available glutamine is at least or about 0.5 mM. In another embodiment, the minimum concentration of available glutamine is at least or about 1 mM, at least or about 2 mM, at least or about 3 mM, at least or about 4 mM. The at least or about concentration can also be any 0.1 increment between 0.5 mM and 20 mM, for example at least or about 4.5 mM, at least or about 6.3 mM etc. The concentration of available glutamine can be up to for example 10 mM, 15 mM or 20 mM.

The organ perfusion solution also includes a colloid component. The colloid component can be or comprise dextran, optionally dextran 40. Other colloids for medical uses are known in the art, such as hydroxyethyl starch (or hetastarch), Haemaccel and Gelofusine.

The organ perfusion solution also includes a salt mixture. The salt mixture can comprise NaCl and/or KCl. In some embodiments, the salt mixture includes one or more of NaCl, KCl, CaCl₂ and MgCl₂. The concentrations can vary, they can for example be or be similar to concentrations available in known perfusion solutions such as STEEN™, OCS, Perfadex™ and others.

The components are comprised in a physiologically acceptable medium. The organ perfusion solution is buffered and the buffer system can comprise a buffer selected from a phosphate buffer, a bicarbonate buffer, a histidine buffer and combinations thereof.

The organ perfusion solution has an osmolarity that is consistent with use in organs. For example, the osmolarity can be from about 280 to about 380 mOsm/L.

The organ perfusion solution can comprise additional components. In some embodiments, the organ perfusion solution further comprises one or more of glucose, optionally D-glucose or glucose monohydrate, mannose and/or fructose.

In some embodiments, the organ perfusion solution further comprises albumin, such as serum albumin.

In some embodiments, the organ perfusion solution or a kit for making the organ perfusion solution further comprises one or more of a sulphate, such as magnesium sulphate, antibiotics such as cefazolin, ciprofloxacin, levofloxacin and/or meropenem an antifungal such as voriconazole, a corticosteroid such as methylprednisolone, one or more vitamins, additional amino acids, insulin, a vasodilator such as milrinone, a nitrate such as nitroglycerin, and dextrose or instructions for adding one or more of the foregoing. The amino acids can be for example non-essential amino acids and/or essential acids. Non-essential amino acids, essential amino acids and vitamins for example can be provided in separate bottles to be added either alone or in combination. Commercial preparations are available.

The additional amino acids can be, for example, other essential or non-essential amino acids including modified amino acids such as citrulline, ornithine, homocysteine, homoserine, β-alanine, amino-caproic acid, and the like, or a combination thereof.

In some embodiments, the organ perfusion solution is acellular. For example, for ex vivo lung perfusion (EVLP) the organ perfusion solution may be acelluar. For other organs such as liver, kidney, pancreas etc., the organ perfusion solution may comprise whole blood, optionally red blood cells or serum, preferably human serum or synthetic serum like additives.

The organ perfusion solution can be made by adding the glutamine component to commercial perfusion solution such as those listed in Tables 1A-D. For example, STEEN perfusion solution can be purchased from XVIVO PERFUSION AB CORPORATION. In one embodiment, the glutamine compound is in powdered form, and is mixed into the perfusion solution until dissolved. In further embodiment, the perfusion solution comprises the components of any one of Tables 1A-1D.

The glutamine compound can be added to the organ perfusion solution or provided separately from the solution and added prior to use.

According to an aspect of the invention, an organ perfusion kit includes a container containing a glutamine compound; and a container containing an organ perfusion solution, the organ perfusion solution comprising a colloid component and a salt mixture in a physiologically acceptable medium.

The glutamine compound can be, as described herein, any glutamine comprising compound that when dissolved provides an accessible source of L-glutamine. In a further embodiment, the glutamine compound is provided as a powder for reconstitution.

According to various embodiments of the kit, the colloid component, the salt mixture and the physiologically acceptable medium are as defined above.

According to various embodiments, the kit comprising the organ perfusion solution further comprises any one of the components listed above. According to various embodiments, the organ perfusion solution has the previously defined osmolarity.

According to various embodiments, the organ perfusion kit comprises an acellular organ perfusion solution.

According to various embodiments, the kit contains one or more containers, which may be sterile. In some embodiments, each constituent component is in a separate container. In another embodiment, one or more of the components are mixed together.

In some embodiments, the organ perfusion solution comprises one or more of the components in Tables 1A-D and a glutamine compound.

The physiological acceptable media can also be a cell culture media to which a colloid and glutamine compound can been added. The cell culture media can contain salt and can also comprise a glutamine compound.

Dulbecco's Modified Eagle Medium (DMEM), where the DMEM contains glutamine, can replace the glutamine compound and the physiological media and optionally the buffer system. Where DMEM does not contain glutamine, DMEM can replace the physiological media and optionally buffer system.

In some embodiments, the organ perfusion solution comprises the components in Table 1A, Table 1B, or Table 1C. In some embodiments, the components of the organ perfusion solution are present in about the concentrations described in any one of Tables 1A-D. In some embodiments, the organ perfusion solution comprises the components and concentrations of Tables 1A-D and a glutamine compound.

TABLE 1A
STEEN Solution
STEEN SOLUTION

| | | |
|---|---|---|
| NaCl | 86 | mM |
| KCl | 4.6 | mM |
| CaCl₂•2H₂O | 1.5 | mM |
| NaH₂PO4•H₂O | 1.2 | mM |
| MgCl₂•6H₂O | 1.2 | mM |
| NaHCO₃ | 15 | mM |
| D-glucose | 11 | mM |
| Dextran | 5 | g/L |
| Albumin | 70 | g/L |
| Cl⁻ | 96 | mM |
| Na⁺ | 102.2 | mM |
| K⁺ | 4.6 | mM |
| Ca²⁺ | 1.5 | mM |
| Mg²⁺ | 1.2 | mM |
| HCO₃⁻ | 15 | mM |
| H2PO4⁻ | 1.2 | mM |

TABLE 1B
PBS Solution
PBS 10010049

| Components | Molecular | Concentration | |
|---|---|---|---|
| Inorganic Salts | Weight | (mg/L) | mM |
| Potassium Phosphate | 136 | 144 | 1.0588236 |
| monobasic (KH2PO4) | | | |
| Sodium Chloride (NaCl) | | 9000 | 155.17241 |
| Sodium Phosphate | 268 | 795 | 2.966418 |
| dibasic (Na2HPO4—7H2O) | | | |

TABLE 1C
Perfadex Solution
Perfadex

| 1000 ml contains | | MW | mM |
|---|---|---|---|
| Dextran 40 50 g | Dextran 40 | | |
| Sodium chloride 8 g | NaCl | 58.5 | 136.75 |
| Glucose monohydrate 1 g | Glucose | | |
| Potassium chloride 0.4 g | KCl | 74.5 | 5.37 |
| Magnesium sulphate 0.098 g | MgSO₄ | 120 | 0.82 |
| Disodium phosphate 0.046 g | Na₂HPO₄ | 142 | 0.32 |
| Monopotassium phosphate 0.063 g | KH₂PO₄ | 136 | 0.46 |

Perfadex contains Na+ 138 mmol, K+ 6 mmol, Mg2+ 0.8 mmol, Cl— 142 mmol, SO4— 0.8 mmol, phosphate 0.8 mmol

TABLE 1D
OCS Solution
OCS solution

| | | | | |
|---|---|---|---|---|
| Dextran 40 | 50 | g | 1.25 | mM |
| Glucose monohvdrate | 2 | g | 10.1 | mM |
| MgSO4•7H2O | 0.201 | g | 0.82 | mM |
| KCl | 0.4 | g | 10.23 | mM |
| NaCl | 8 | g | 136.89 | mM |
| NaH₂PO4•2H₂O | 0.058 | g | 0.33 | mM |
| KH2PO4 | 0.063 | g | 0.46 | mM |

Standard OCS Lung additives: (1 g cefazolin, 200 mg ciprofloxacin, 200 mg voriconazole, 500 mg methylprednisolone, 1 vial multivitamins, 20 IU regular insulin, 4 mg milrinone, 20 mEq NaHCO3, 50 mg nitroglycerin, and a 50% dextrose solution)

The solutions described herein can be made and used as described herein, or any way known to the person skilled in the art, for example as described in U.S. Pat. No. 7,255,983, which is incorporated herein by reference in its entirety.

The organ perfusion solutions described herein are particularly suitable for extended ex vivo perfusion, and for example for use in methods and with systems described herein. Accordingly, in some embodiments, the organ perfusion solutions provided herein are for use in methods of extended EVP.

Also provided is a dialysate composition or a kit comprising said composition for use as described herein.

Commercial dialysate can contain only NaCl. One or more of the components described in Example 8 may be added and are for example for use with the methods and systems described herein. The kit can comprise a NaCl dialysate in one container (e.g., a bag) with one or more containers comprising one or more of the components in Example 8, for addition to the NaCl dialysate at a later time (e.g., upon use).

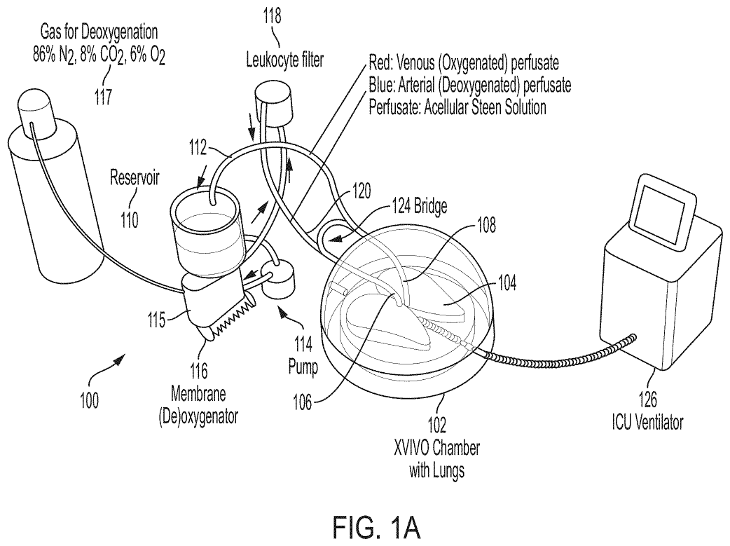

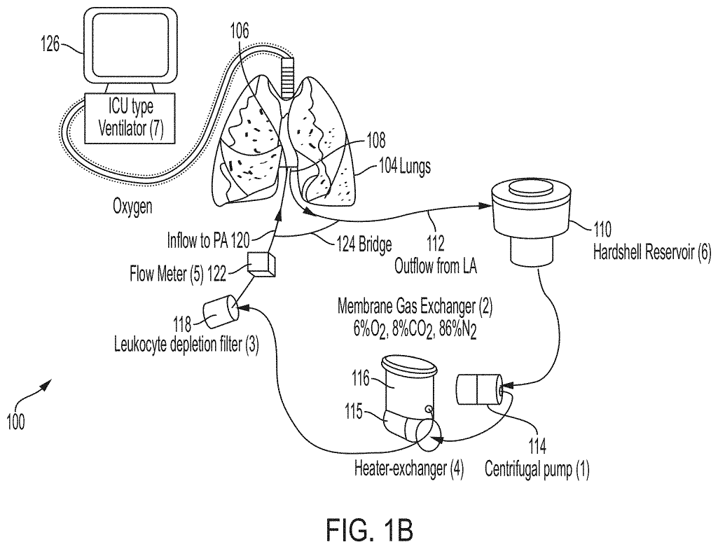

According to various embodiments, the organ perfusion solution that includes a glutamine compound can be used to perfuse an organ using an ex vivo organ perfusion apparatus. An organ perfusion apparatus 100 suitable for ex vivo perfusion of a lung is illustrated in FIGS. 1A and 1B. The organ perfusion apparatus 100 includes a chamber 102 for positioning the lung 104. An inlet 106 connects to the lung 104 via the pulmonary artery (PA) and the outlet 108 connects to the lung by the pulmonary vein (PV) that in vivo connects to the left atrium (LA). Preferably the LA is sealed to the conduit (e.g., outlet cannula) and can be referred to as a closed atrium. Organ perfusion solution, such as any of the organ perfusion solutions described above, flows into the lung 104 via the inlet 106 and flows out of the lung 104 via the outlet 108.

Organ perfusion solution that has passed through the lung 104 flows into a reservoir 110 via a return fluid path 112 via action of a pump 114 that is located downstream of the reservoir 110. Perfusion solution passes through the pump 114 to a heat exchanger 115 and then through a membrane (de)oxygenator 116 that may receive deoxygenating gas from a tank 117. Perfusion solution then passes through a leukocyte filter 118 before flowing via a delivery fluid path 120 to the lung 104. A bridge 124 may be provided between the delivery fluid path 120 and the return fluid path 112. A flow meter 122 may be provided in the delivery fluid path 120 or any other location in the perfusion circuit. A ventilator 126 may be used to provide oxygen to the lungs 104.

II. Systems and Methods Combining Dialysis with EVLP

EVLP maintains marginal donor lungs at body temperature with ventilation and circulating perfusate, allowing for functional assessment prior to transplantation. Prolonged EVLP could allow for advanced time-dependent therapies for donor lung repair and reconditioning. The inventors hypothesized that the addition of a dialysis machine to the EVLP circuit would maintain homeostasis of the donor lung and prolong EVLP duration. As demonstrated herein, using a “hemodialysis” machine on at least a portion of the perfusion solution circulating through the organ during EVLP, through the integration of dialysis with EVLP as described in the Examples herein, greatly prolongs organ longevity. For example, in studies performed by the inventors, after 24 hours of EVLP and integrated dialysis, 100% of lungs tested were maintained whereas under similar conditions without integrated dialysis, only 20% of the lungs were maintained.

Accordingly, another aspect described herein is an organ perfusion system that includes an organ perfusion apparatus, such as similar to apparatus 100 of FIGS. 1A and 1B, for perfusing an organ with organ perfusion solution and an integrated continuous fluid dialysis machine that dialyzes at least a portion of the organ perfusion solution.

According to various embodiments, the organ perfusion apparatus includes: an organ perfusion device that includes an inlet for connecting to the organ via an input vessel of the organ, an outlet for connection to the organ via an output vessel of the organ, a perfusion circuit that includes a reservoir for holding organ perfusion solution, a waste receptacle, and a plurality of fluid conduits defining a delivery fluid path connecting the reservoir with the inlet, a return fluid path independent of the delivery fluid path connecting the outlet with the reservoir, a dialysis fluid diversion path, and a dialysis fluid return path.

The integrated continuous fluid dialysis machine can include a dialyzer unit having a dialysate container for holding dialysate, a waste container for holding waste dialysate, and a dialyzer. The dialyzer may include a perfusion import port for receiving fluid to be dialyzed and for connecting to the conduit defining the fluid diversion path, a perfusion export port for returning fluid that has been dialyzed and for connecting to the conduit defining the fluid return path to the export port of the dialyzer, a dialysate import port fluidly connected to the dialysate container; and a dialysate export port fluidly connected to the waste container. The dialysis also includes a dialysis filter cartridge.

The organ perfusion system may be configured to permit a flow rate of about 0.1 L/min to about 3 L/min through the perfusion circuit and the organ, about 50-200 ml/minute, preferably 100 ml/minute, through the dialysis flow path and the dialyzer. The dialysis machine may be configured to permit dialysate to flow at a flow rate of about 150-400 ml/hour, optionally about 300 ml/hour.

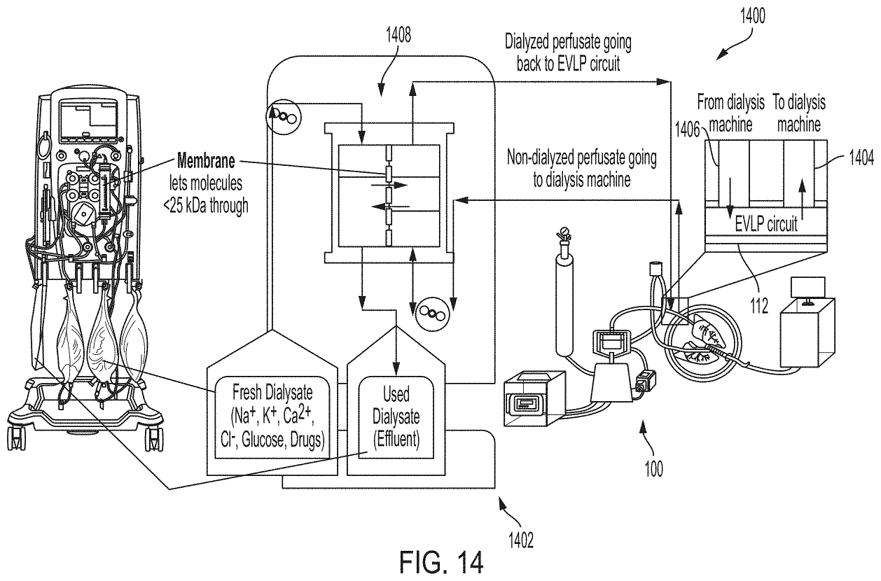

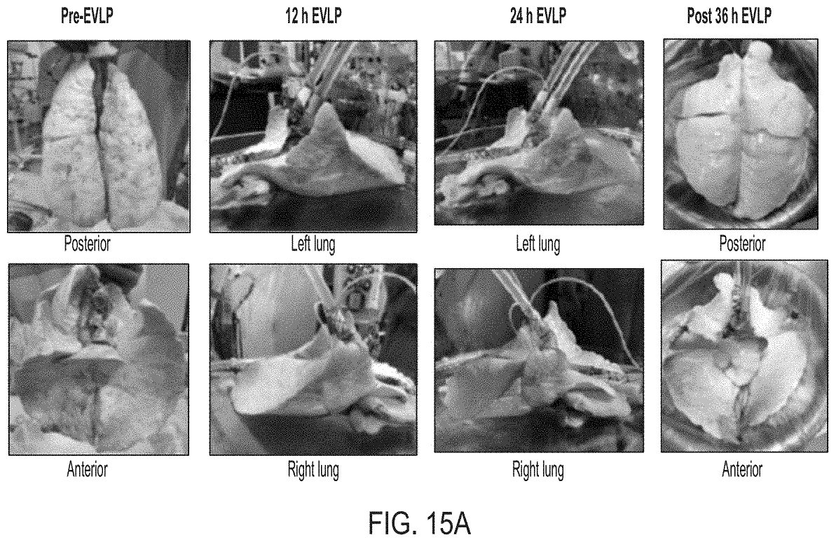

An exemplary organ perfusion system 1400 for perfusing a lung is illustrated in FIG. 14. The organ perfusion system 1400 includes an organ perfusion apparatus that can be substantially similar to organ perfusion apparatus 100 of FIG. 1. As such, description of the components of the organ perfusion apparatus are not repeated here for simplicity.

System 1400 also includes an integrated continuous fluid dialysis machine 1402 that dialyzes at least a portion of the organ perfusion solution. A portion of the organ perfusion solution is diverted for dialysis through the dialysis machine 1402. The diversion of circulating organ perfusion solution can be from either organ perfusion conduit. This can be accomplished by cannulating the conduit that defines the delivery fluid or the return fluid path, preferably the return fluid path, of the organ perfusion solution. Accordingly, in the illustrated embodiment, the conduit that defines the dialysis fluid diversion path 1404 and the conduit that defines the dialysis fluid return path 1406 cannulate the conduit that defines the return fluid path 112 connecting the outlet with the reservoir.

Various dialyzers 1408 may be used. Preferably the dialysis filter cartridge of the dialyzer 1408 is one that is permissive for dialyzing out molecules that have a molecular weight of less than or about 30 kDa, optionally less than or about 25 kDa. The dialysis filter cartridge can comprise a polyarylethysulfone (PAES) membrane and may be suitable for ultrafiltration of solutes with minimal protein absorption. Suitable cartridges include the HF 1400 CRRT set, which is for use with Prismaflex dialysis machine. According to various embodiments, the dialysis machine is suitable as it allows for continuous flow dialysis. Preferably in some embodiments, the dialysis machine is configured to perform continuous veno-venous hemodialysis without filtration. Other modes that permit for a low flow rate, can also be used.

In some embodiments, the organ perfusion device further comprises a waste fluid path independent of the inlet, the outlet and the return fluid path, connecting the reservoir with the waste receptacle for directing the perfusion fluid from the reservoir to the waste receptacle without traversing the organ.

As explained above with respect to the organ perfusion apparatus 100 of FIGS. 1A and 1B. The organ perfusion apparatus 100 of system 1400 can further comprise an organ chamber for receiving the organ, a pump for pumping organ perfusion solution through the organ perfusion circuit and the dialysis machine, one or more flow meters, a blood cell filter such as a leukocyte filter for capturing blood cells flushed from the organ during perfusion, a gas exchanger for deoxygenating the perfusion solution for the lung (or a oxygenator for other solid organs, such as liver, kidney, heart, etc.), a heater/heat exchanger, a ventilator when the organ is a lung or lungs and/or gas source for providing for example carbon dioxide to the deoxygenator (or oxygen to oxygenator). For example, the organ perfusion apparatus can comprise the components or similar components to those shown in FIGS. 1A and 1B.

In some embodiments, the system 1400 includes a ventilator that can, for example, comprise functionality to measure lung function. The perfusion pump can comprise functionality to measure the PA pressure and calculate the PVR automatically.

Suitable organ perfusion devices can comprise the XVIVO Perfusion System (XPS™) which consists of the XPS™ Perfusion Cart Hardware, fluid path and non-fluid path disposables, XPS™ Cart Software and said device can be used for example with and STEEN Solution™. The XPS™ System provides an organ chamber for housing a lung and providing an environment close to body temperature, as well as the circuit for perfusing the organ with the STEEN Solution™.

Organ perfusion devices include those described in for example U.S. patent application Ser. No. 13/447,025, U.S. patent application Ser. No. 16/113,559, U.S. Pat. No. 9,835,630, U.S. patent application Ser. No. 14/769,425, and U.S. Pat. No. 10,091,986 as well as Cypel M, Yeung J C, Hirayama S, Rubacha M, Fischer S, Anraku M, Sato M, Harwood S, Pierre A, Waddell T K, de Perrot M, Liu M, Keshavjee S. Technique for Prolonged Normothermic Ex Vivo Lung Perfusion. J. Hear. Lung Transplant. 2008; 27(12):1319-1325, each hereby incorporated by reference in its entirety.

According to various aspects, a method for machine perfusion of an organ includes circulating an organ perfusion solution through the organ using an organ perfusion device; and continuously dialyzing a portion of the circulating organ perfusion solution with a dialysate using an integrated dialysis machine. Optionally, the perfusion and/or the dialysis is performed for at least 4 hrs, or for at least 8 hrs.

As shown in the Examples, organ perfusion solutions comprising a glutamine compound, can extend the use of EVP. Accordingly, another aspect is a method for machine perfusion of an organ comprising: circulating an organ perfusion solution comprising a glutamine compound through the organ using an organ perfusion device (that may include dialysis), where the perfusion and/or the dialysis is performed for at least 8 hrs.

Organ perfusion solutions and kits described herein can optionally be used.

Circulating the organ perfusion solution can be performed under normothermic (e.g., 37° C.) conditions (normothermic EVP, optionally EVLP). For example, the organ perfusion device can maintain the environment and/or the organ perfusion solution at about 37° C. Organ perfusion can also be performed at temperatures lower than 37° C., such as 31° C., 10° C., etc.

During perfusion, the organ perfusion solution, which is held in a reservoir, is circulated through the organ continuously or in a pulsatile manner (pulsatilely). The organ perfusion solution can be replenished or replaced after a set period of time, for example at or after every hour, at or after every 2 hours, or at or after every 3 hours or at or after every 4 hours.

The dialysate may comprise a salt solution (e.g., Na+ 140 mmol/L, K+ 4 mmol/L, Ca2+ 0.8 mmol/L).

Various dialysis modes can be used according to the systems and methods described herein. For example, the dialysis machine can be configured for continuous veno-venous hemodialysis without filtration.

The organ perfusion device and the integrated dialysis machine can be an organ perfusion system described herein. The organ perfusion device can also be a simplified system with basic parts or modified parts.

In some embodiments, the method comprises obtaining an organ, introducing the organ into an organ perfusion device, and/or an organ perfusion system, such as one described herein.

The organ perfusion apparatus can be configured so that the organ perfusion solution enters the organ at a controlled flow rate and may exit the organ at substantially the same flow rate. The controlled flow rate may be between 0.1 to 3 liters per minute. For example, the organ perfusion solution may enter and/or exit the organ at a flow rate of about 0.2 liters per minute, 0.5 liters per minute, 1 liter per minute, 1.5 liters per minute, 2 liters per minute or 2.5 liters per minute. The perfusion flow rate can be selected based on the organ size or organ type and/or can be determined by experimental results.

The dialysis machine can also be configured so that the organ perfusion solution is diverted for dialysis at a controlled flow rate. For example, the flow rate of the organ perfusion solution through the dialysis flow path and dialyzer can be configured to permit a flow rate of about 50 milliliters/hour to about 200 ml/hour, preferably about 100 milliliters/hour. For example, where the perfusion flow rate through the organ is 1.5 liters/hour, about 100 milliliters/hour can be diverted to be dialyzed and 1.4 liters/hour can continue through the perfusion circuit.

Dialysate through the dialysis machine (e.g., 1402 of FIG. 14) can flow at a flow rate of about 150 milliliters/hour to about 400 milliliters/hour, preferably about 300 milliliters/hour.

During perfusion, the organ can be first warmed to, for example, 37° C. Although, temperatures from 4° C. to about 37° C., such as 31° C., can be used. Organ perfusion solution can be slowly circulated through the perfusion path, such as starting at about 100 milliliters/min and ramping up to, for example, 1.5 liters/min. Dialysis of the perfusion solution can begin when the organ perfusion solution is circulating at the desired rate—e.g., 1.5 liters/min. Accordingly, the organ may be perfused for a longer time than the organ is dialyzed. For example, the perfusion may be 30 minutes longer, 1 hour longer, 2 hours longer or more.

The organ perfusion solution can comprise glucose, an antimicrobial cocktail, a corticosteroid such as methylprednisolone, and/or an anticoagulant such as heparin. Other components such as therapeutic agents can also be added. These can be added for example to the organ perfusion when in the reservoir or prior to its placement in the reservoir and/or during replenishment or replacement of the organ perfusion solution.

One or more of these components can also be added to the dialysate. Accordingly, in some embodiments the dialysate comprises an antimicrobial cocktail, a corticosteroid such as methylprednisolone, and/or an anticoagulant such as heparin. Examples are provided in Example 8. One or more of the components described therein can be added.

The antimicrobial cocktail can comprise one or more agents. In some embodiments, the antimicrobial cocktail comprises one or more of cefazolin, ciprofloxacin, levofloxacin, meropenem and voriconazole. In another embodiment, the antimicrobial cocktail comprises levofloxacin and/or meropenem.

In some embodiments, the organ perfusion solution further comprises whole blood or a blood cell fraction such as red blood cells or serum. For example, such organ perfusion solutions can be used with lung, or non-lung organs such as heart, liver, kidney, pancreas and bowel.

The methods described herein can permit extended EVP. Accordingly in some embodiments, circulating of the organ perfusion solution and/or the dialyzing is performed for at least or about 4 hours, 6 hour, 8 hours, 10 hours, 12 hours, 14 hours, 16 hours, 18 hours, 20 hours, 22 hours, 24 hours, 26 hours, 28 hours, 30 hours, 32 hours, 34 hours, or 36 hours or longer. For example, the method can be performed for up to 48 hours, and even longer.

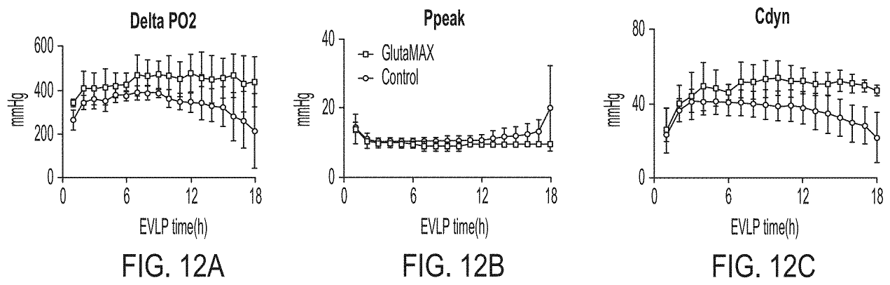

During the method, the organ can be monitored for one or more indicators of health, for example by performing one or more functional tests. As described in the examples, for lungs this can include assessing delta PO2, dynamic compliance and peak airway pressure. As shown for example in FIG. 12, lung functional test results measuring delta PO2, dynamic compliance and peak airway pressure demonstrate that lungs perfused with GlutaMax-modified Steen solution had improved function compared with historical controls.

After a suitable time, the organ can be assessed for and/or transplanted. For example, the method can comprise attempting to repair a marginal organ and determining if the organ is suitable for transplant or if the organ will be declined for transplant. If for example, the organ functional tests suggest that the organ is suitable, the organ is so identified. In some embodiments, the method further comprises transplanting the organ.

Accordingly, also provided is a method for determining if an organ is suitable for transplant, the method comprising:

(i) circulating an organ perfusion solution through the organ using an organ perfusion device and continuously dialyzing a portion of the circulating organ perfusion solution with a dialysate using an integrated dialysis machine (optionally, the perfusion and/or the dialysis is performed for at least 4 hrs or at least 8 hrs), or
circulating an organ perfusion solution comprising a glutamine compound through the organ using an organ perfusion device (optionally, the perfusion and/or the dialysis is performed for at least 4 hrs or at least 8 hrs);

(ii) assessing the organ during or subsequent to (i); and

(iii) identifying the organ as suitable or not suitable for transplant.

In some embodiments, the method further comprises transplanting the organ.

Also provided in another aspect, is a method of improving and/or repairing an ex vivo organ, said method comprising the steps of: determining the status of the organ by evaluating pre-selected criteria (for example lung compliance or other criteria assessed in the Examples); subjecting the organ to the organ perfusion system optionally using an organ perfusion solution, dialysate composition described herein for a period of time; and determining improvement of the organ by re-evaluating the pre-selected criteria.

The organ can be a lung, liver, heart, kidney, bowel or pancreas. In some embodiments, the organ is a lung or set of lungs. The organ can for example be a donation after circulatory death (DCD) organ e.g., a DCD lung. The organ can for example be a donation after brain death (DBD) organ, such as a DBD lung.

In embodiments where the organ is a lung, the pre-selected criteria can include dynamic compliance. In an embodiment, the re-evaluated dynamic compliance is 15 ml/cmH₂O or higher.

In some embodiments, the period of time is at least 24 hours. The period of time can for example be the time wherein the organ is rendered suitable for transplantation into a human.

As described herein, the methods can further comprise subjecting the organ to a therapeutic agent.

Also provided in another aspect is a repaired and/or improved organ suitable for transplantation in a human, wherein the repaired and/or improved organ was repaired and/or improved using the methods, compositions (organ perfusion solution and/or dialysate composition), or systems described herein, in some embodiments wherein the organ had been assessed as being unsuitable for transplantation into a human before subjection to the organ perfusion system, and was determined to be suitable for transplantation subjection to the organ perfusion system.

It is understood that the methods described and the organs to which the methods and systems are applied are ex vivo.

The extended EVP can be used to increase utilization of donor lungs, reduce ischemia related (IR) injury and primary graft dysfunction (PGD), and decrease the likelihood of thrombolysis. As mentioned, antimicrobials can be added which can reduce bacterial growth. Further therapeutics can be added to the organ perfusion solution and optionally the dialysate. For example, if an organ is recovered from a donor that has a treatable infection such as hepatitis C virus (HCV), extended EVP could be performed to reduce viral load and/or administer a therapeutic agent for an increased period of time.

Accordingly, a further aspect is a method for delivery of a therapeutic agent to an ex vivo organ for transplant comprising obtaining the organ, the organ having preferably been flushed with a non-blood physiologic solution; introducing the organ into an organ perfusion device and integrated dialysis machine, the organ perfusion device comprising a reservoir comprising organ perfusion solution, the dialysis machine comprising a dialysate container comprising organ dialysate, the organ perfusion solution and optionally the organ dialysate comprising the therapeutic agent; circulating the organ perfusion solution comprising the therapeutic agent through the organ using the organ perfusion device; and dialyzing a portion of the organ perfusion solution as it circulates through the organ using the integrated dialysis machine.

As demonstrated in the Examples, the organ perfusion solutions comprising a glutamine compound and systems comprising an integrated dialysis machine, increases the time EVP organs can be exposed to while maintaining organ health. Accordingly, in some embodiments, the organ perfusion solution, the organ perfusion kit, the method or the organ perfusion system described herein, is for use for extended ex vivo perfusion (EVP).

Different organs can be perfused. In some embodiments, the organ is a lung or set of lungs. When the organ is a lung, acellular organ perfusion solutions can be used, and the organ perfusion device comprises a ventilator. In some embodiments, for example for using glutamine compound comprising organ perfusion solutions, the organ is selected from liver, heart, kidney, pancreas or bowel. For other embodiments, for example comprising using a dialysis machine, the organ is selected from liver, heart, kidney, pancreas or bowel. When the organ is a liver, heart, kidney, pancreas or bowel, organ perfusion solutions comprising whole blood or parts thereof, may be used.

Other methods are also provided. For example, during EVP, the organ can be subjected to for example gene therapy, optionally gene editing, stem cell therapy or immunologic modulation.

The methods described herein can be combined.

A more complete understanding can be obtained by reference to the following specific examples. These examples are described solely for the purpose of illustration and are not intended to limit the scope of the application. Changes in form and substitution of equivalents are contemplated as circumstances might suggest or render expedient. Although specific terms have been employed herein, such terms are intended in a descriptive sense and not for purposes of limitation.

The following non-limiting examples are illustrative of the present disclosure:

### EXAMPLES

### Example 1

EVLP provides opportunities for donor lung repair (e.g., pharmacological treatment, gene or stem cell therapy) and reconditioning (e.g., immunomodulation, gene editing) and regeneration (e.g., exogenous stem cells to repopulate decellularized lung scaffolds). However, clinical EVLP systems are approved to support donor lungs for up to 6 h, and most experimental studies in animals are limited to 12 h. A prolonged EVLP time window of 36 h and beyond is required to enable the full and effective use of these advanced therapies.

Extending organ perfusion ex vivo has become a major challenge, especially in lung transplant research. According to various aspects of the systems and methods described herein, Steen solution has been modified to improve EVLP performance. Further, according to some embodiments, EVLP has been extended using the Toronto acellular EVLP system and an integrated hemodialysis, as discussed above. Using this technique, EVLP can be been extended to 36 h and beyond.

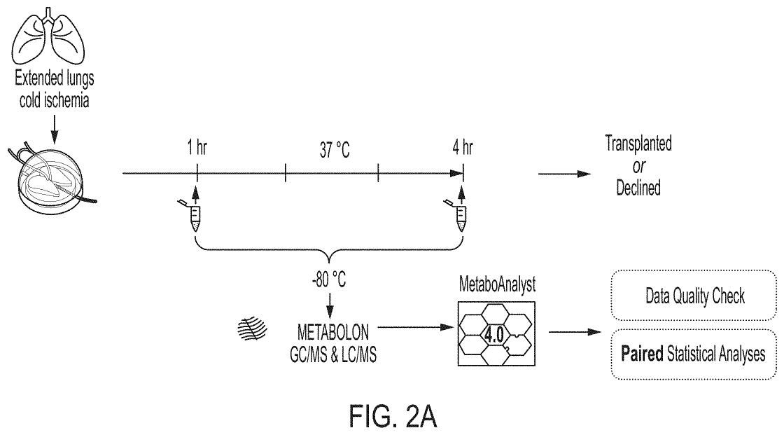

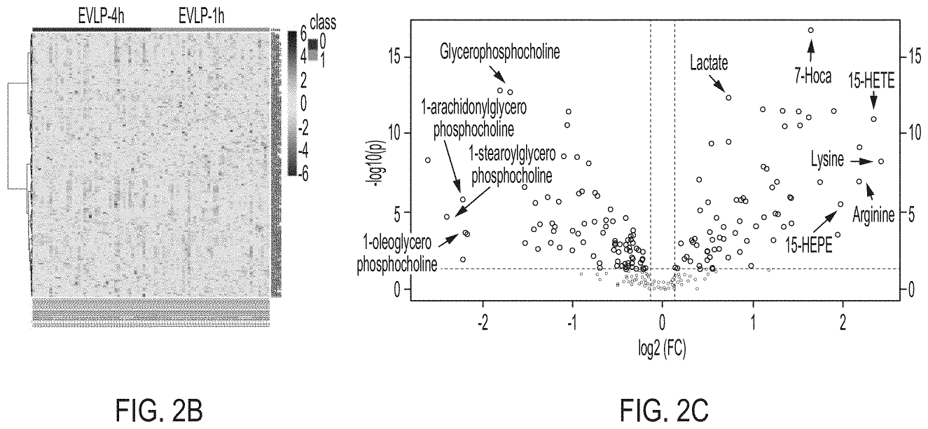

Although it has been generally viewed that lungs are less metabolically active as compared to other solid organs, metabolomics studies were performed using perfusate samples collected at 1 h and 4 h of EVLP from 42 human donor lungs. FIG. 2A illustrates the metabolomics study process.

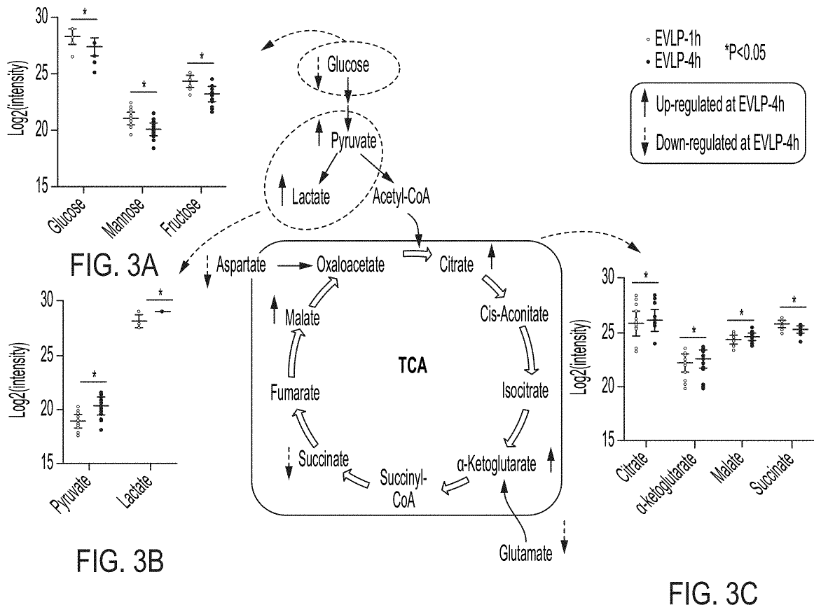

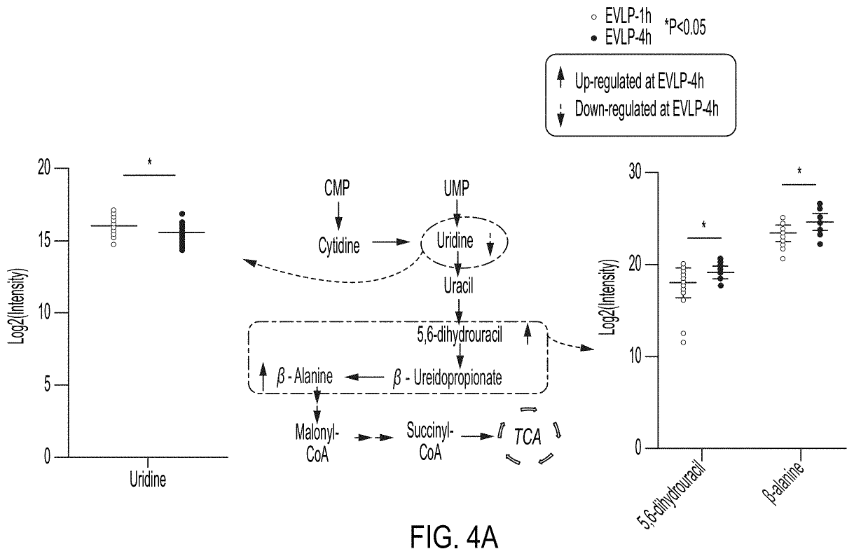

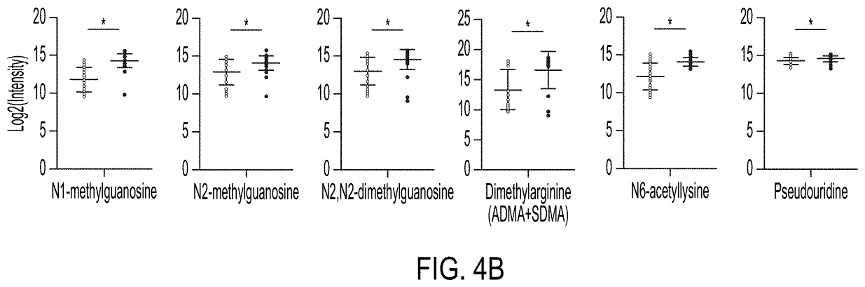

In total, 275 biochemical substances were detected in the metabolomics study. Biomarkers that predict PGD have been reported. The study data show that metabolites are differentially expressed between 1 hour and 4 hour samples. The heat map of FIG. 2B shows the global differential metabolite levels at 1 hour and 4 hour, and the volcano plot of FIG. 2C shown the metabolites that were most significantly changed. Importantly, metabolite changes during EVLP are consistent with increased carbohydrate metabolism. Glycolysis substrates, glucose, mannose and fructose, were decreased in the perfusate (FIG. 3A), while pyruvate and lactate were significantly increased (FIG. 3B), as were several intermediates in the TCA cycle (FIG. 3C). Levels of aspartate and glutamate, amino acids used for energy production via the TCA cycle and for nucleotide de novo synthesis were also decreased (not shown). Together, these results reveal an anabolic lung state that consumes glucose and other nutrients for energy production. Accumulation of pyrimidine and RNA degradation products was also observed in the perfusate, as shown in FIGS. 4A and 4B. These results indicate that for current clinical EVLP, metabolism is not optimal. Based on this, the inventors concluded that to improve EVLP we should add proper nutrients to the perfusate in order to maintain metabolism and promote tissue repair, and to extend EVLP the accumulation of metabolic by-products should be prevented.

Methods used are further described in Example 7.

### Example 2

Methods: Human pulmonary microvascular endothelial cells (HPMEC) and human lung epithelial cells (BEAS-2B) were used to determine the effects of Steen solution components on basic cellular function. Cell confluence, apoptosis and migration were visualized and quantified by IncuCyte® Live Cell Analysis System in real-time. A simulated EVLP cell culture model was established by replacing regular culture medium with cold lung preservation solution and followed by “perfusion” with normothermic Steen solution or its modifications. Cell apoptosis was quantified. Porcine lung EVLP was performed using Steen solution with added nutrients.

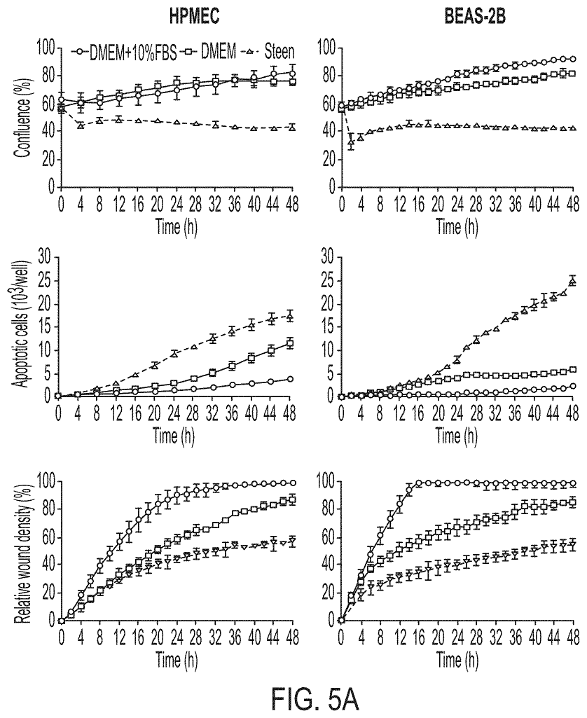

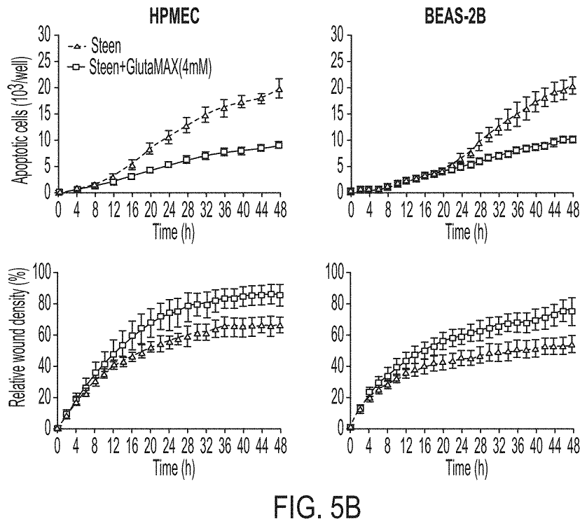

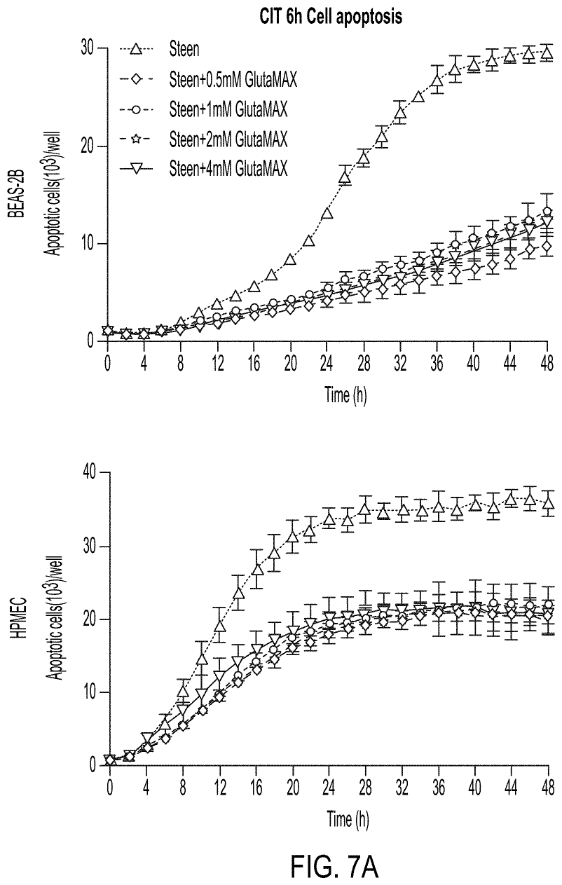

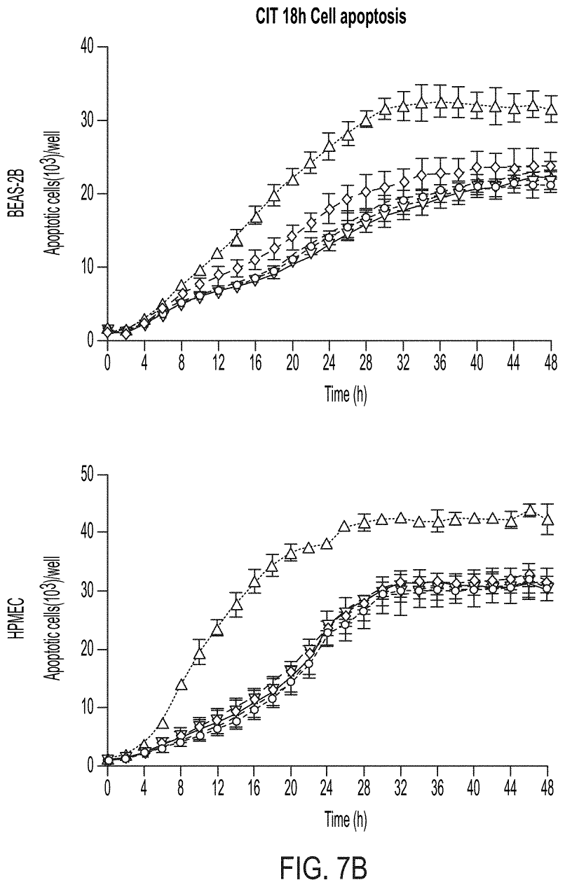

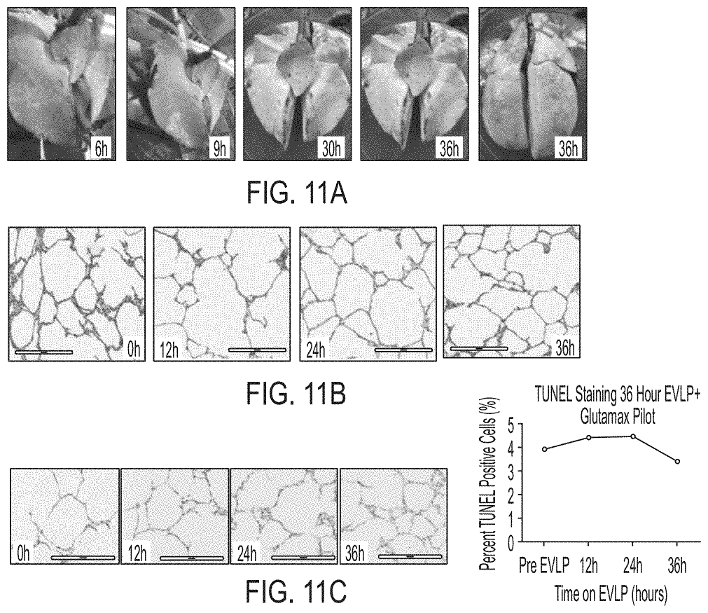

Results: Cells exposed to Steen solution exhibited reduced cell confluence, increased apoptosis and suppressed cell migration compared to DMEM or DMEM+10% FBS (FIG. 5A). In an examination of adding various nutrients to Steen solution on cell function, L-alanyl-L-glutamine (gln) significantly inhibited cell apoptosis and improved cell migration (FIG. 5B). In the simulated EVLP cell culture setting, adding gln to Steen solution significantly reduced apoptosis (FIG. 7). In pig lung EVLP, the addition of gln to Steen solution significantly extend the EVLP period (FIG. 11) with stable lung function (FIG. 12A-C).

Conclusion: Glutamine is the most abundant free amino acid in the body with multiple cytoprotective functions. Adding L-alanyl-L-glutamine to EVLP perfusate, according to various aspects of the systems and methods described herein, improves the stability and function of lungs being evaluated and treated with EVLP. Further details are provided in Example 3.

### Example 3

### Modified Perfusate Improves EVLP Performance

Rationale: Donor lung function assessment is currently the primary application of EVLP. Our metabolomics studies, however, indicate that even for 4 h clinical EVLP, glucose and other “energy molecules” were reduced (FIG. 3A-C), and metabolic by-products were accumulated (FIG. 4A-B), indicating that cellular metabolism is not optimal.

Steen solution is the gold standard perfusate, approved by Health Canada, FDA and other regulatory agencies. The inventors discovered that adding specific nutrients to Steen solution may improve clinical EVLP performance and enhance donor lung quality prior to transplant. Cell cultures were used to test the effects of Steen solution and its components on basic cellular functions, an essential additive was selected and tested with an EVLP-cell culture model and tested on pig EVLP (FIGS. 5A-B).

Steen solution inhibits cell migration and promotes apoptosis. Steen solution contains phosphate and bicarbonate buffer, glucose (as an energy source), a high concentration of albumin (7%, to maintain high colloidal osmolarity), and a low dose of Dextran 40 (5 g/L, to improve microcirculation). Compared with DMEM (a commonly used cell culture medium) or DMEM plus 10% FBS (contains growth factors and other biological factors), Steen solution reduces cell confluence, induces apoptosis and inhibits cell migration in human pulmonary microvascular endothelial cells (HPMEC) and human lung epithelial BEAS2B cells (FIG. 5A).

Different concentrations of Albumin (1, 2, 4, 7%) and Dextran 40 (5, 25, 50 g/L) in Steen solution were studied on cell confluence, apoptosis and migration and no major differences were found.

Amino acids are essential nutrients for cell proliferation. In rat lungs, the lack of amino acids and insulin in perfusate reduced protein synthesis, while vitamin C prolonged the viability and stability of perfused rat lungs by slowing the decline of mitochondrial activity. Therefore, clinically recommended concentrations of amino acids and/or vitamins were added in Steen solution to improve its performance. Addition of essential amino acids, nonessential amino acids, either alone, or in combination with vitamins, resulted in significantly reduced pH. This result suggests the buffering capacity of Steen solution is very low and needs to be improved.

GlutaMax significantly improved Steen solution for cellular function: GlutaMax (a commercial form of glutamine) was added at 4 mM. The pH was maintained in the physiological range, apoptosis was reduced, and cell migration was improved in both human lung endothelial and epithelial cells, as shown in FIG. 5B.

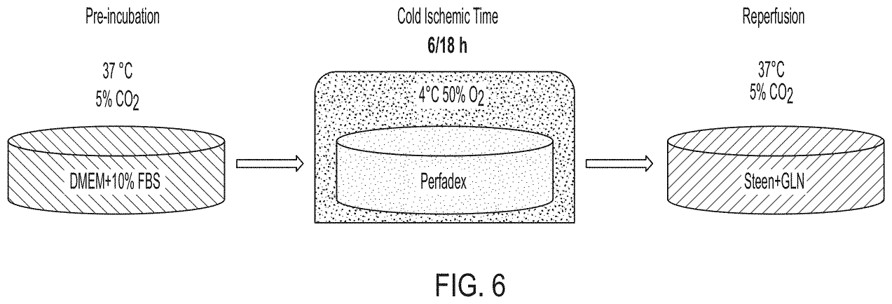

A cell culture model was developed that simulates hypothermic lung preservation and reperfusion and was used to “perfuse” cells with EVLP perfusate, as shown in FIG. 6A. Culture medium of confluent cells was replaced with 4° C. lung preservation solution (Perfadex®) for 6 h or 18 h, and then “perfused” with Steen solution with and without GlutaMax.

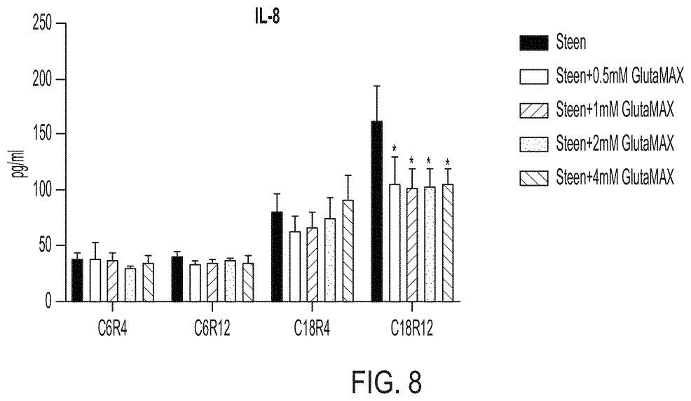

Effects of GlutaMax-modified Steen solution on cell functions: GlutaMax (from 0.5 mM to 4 mM) reduced apoptosis of BEAS-2B and HPMEC cells after either 6 h or 18 h cold preservation during simulated EVLP, as shown in FIG. 7. GlutaMAX inhibited IL-8 production after prolonged CIT (18 hours) and EVLP (12 hours), as shown in FIG. 8.

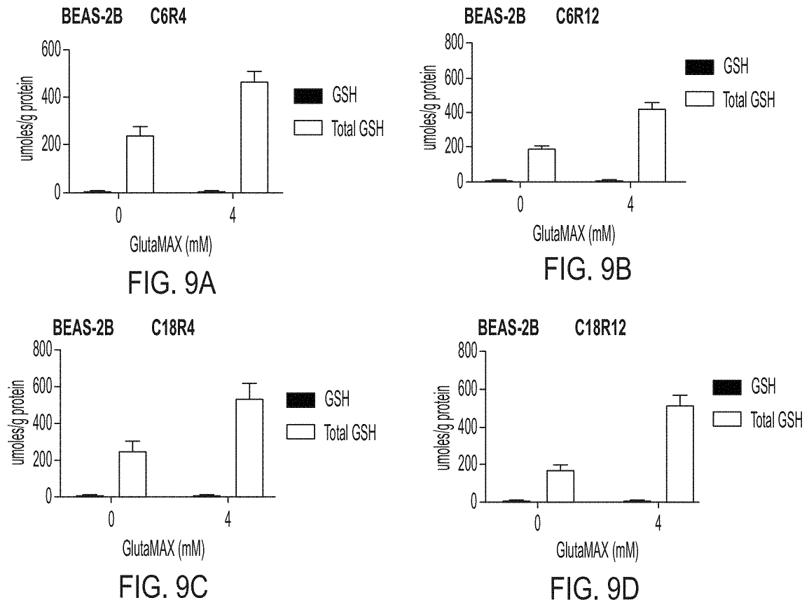

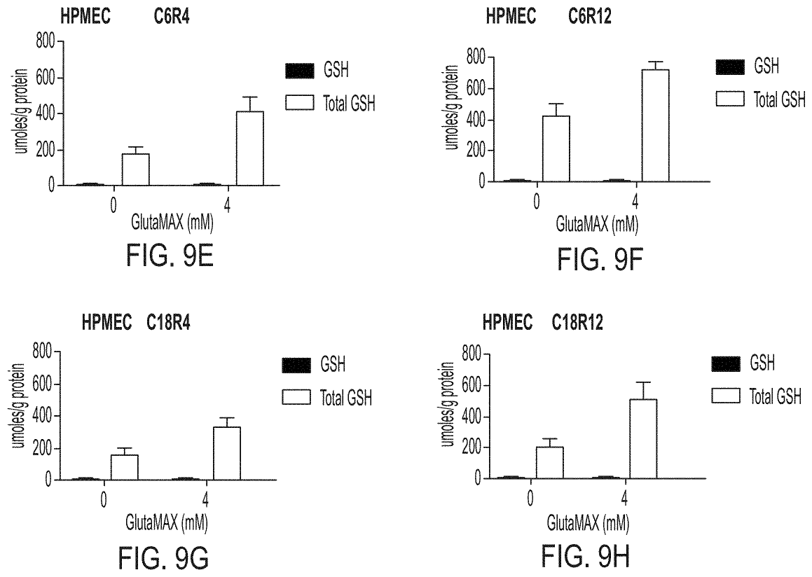

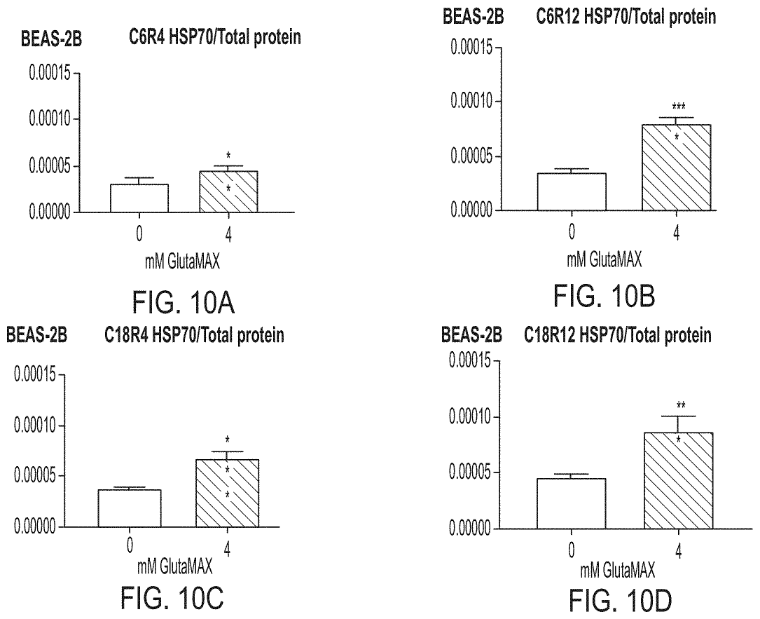

Human lung endothelial and epithelial cells were subjected to simulated EVLP treated with Steen solution with and without GlutaMax. GSH concentration in cell culture was measured with a fluorometric assay kit from BioVision. GlutaMax enhanced total GSH production, as shown in FIG. 9A-H. Similarly, protein expression levels of HSP70 in cell lysates was examined and showed that GlutaMAX promoted HSP70 production, as shown in FIG. 10A-D.

The effects of glutamine in Steen solution on mitochondrial respiration and glycolytic function were examined using a Seahorse XFe analyzer. In initial studies, Steen solution changed the ultrastructure of human lung endothelial and epithelial cells, especially the morphology of mitochondria.

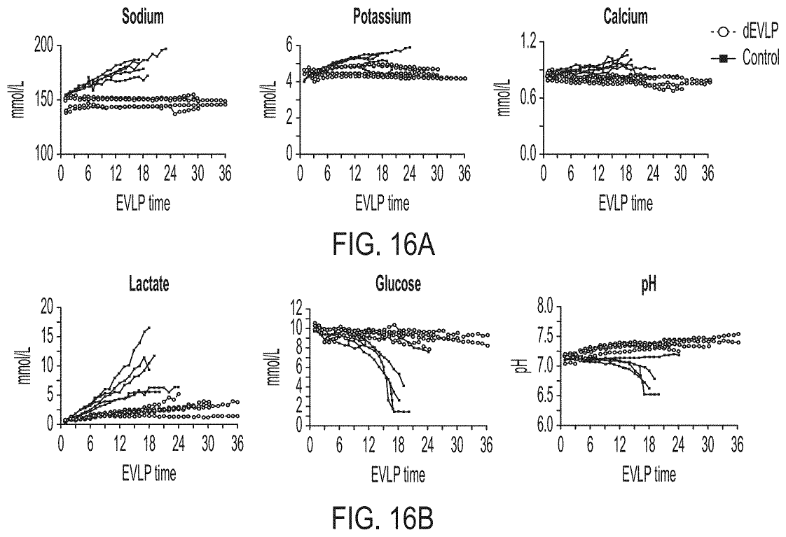

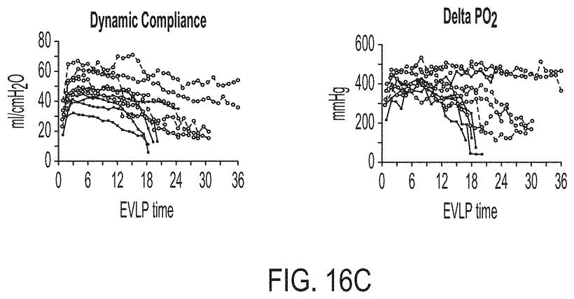

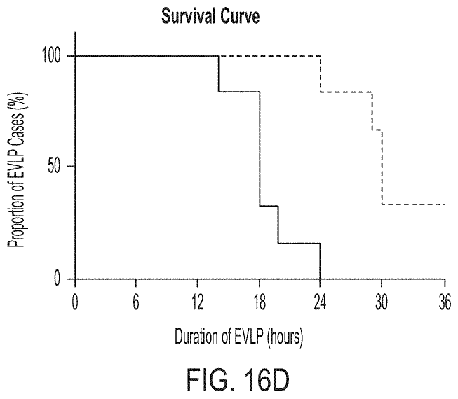

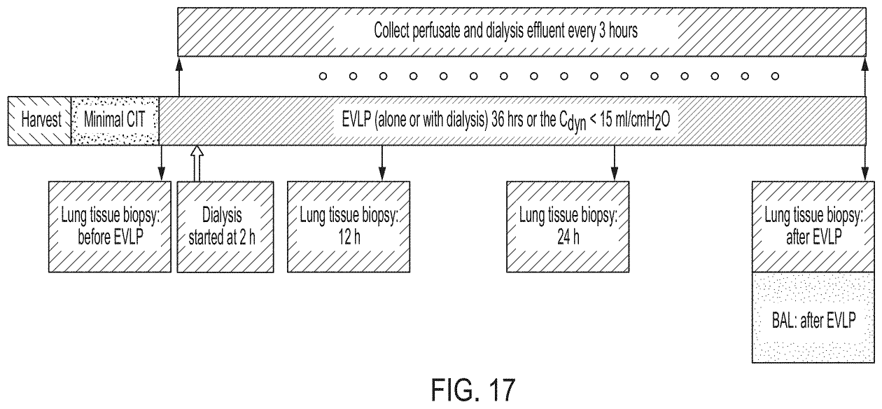

According to various embodiments, GlutaMax-modified Steen solution extended EVLP, as shown in the following study. The experimental design and lung function assessment were conducted as shown in FIG. 17. During the experiment, EVLP was extended as long as the dynamic lung compliance was greater than 15 ml/cmH₂O. Of the 2 lungs treated with GlutaMax-modified Steen solution, one reached 36 h and another 21 h whereas Steen solution perfused lungs crashed between 14 to 24 hours, as shown in FIG. 16D. The 36 h EVLP lung had good results in its gross appearance (FIG. 11A), histology (FIG. 11B) and level of apoptosis (FIG. 11C). Lung functional test results for the first 18 h are shown in FIG. 12A-C. Delta PO2, peak airway pressure and dynamic compliance are better in GlutaMax-modified Steen solution compared with historical control, as shown in FIGS. 12A-C.

### Example 4

Porcine donor lungs (n=3) were extracted and placed on an EVLP platform for 36 hours or until termination criteria (dynamic compliance<15 ml/cmH₂O) was reached. Lungs were perfused with an acellular solution and closed atrium, according to the Toronto EVLP protocol. A dialysis machine, according to various aspects of the systems and methods herein, was incorporated into the EVLP circuit with a custom-designed dialysate, as described in Example 8, and used to continuously dialyze perfusate using continuous veno-venous hemodialysis. Physiological function, electrolytes and inflammatory mediators in EVLP perfusate were measured hourly. In this pilot study, dialysis cases were compared to historical controls with similar protocol.

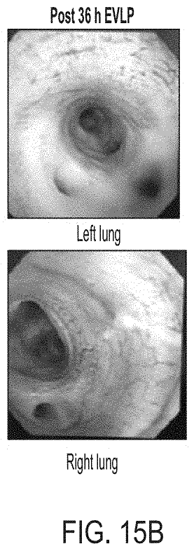

The results showed that dialysis successfully prevented an increase in electrolyte levels, as shown in FIG. 16A, and maintained glucose and lactate levels at baseline, as shown in FIG. 16B. Better compliance and oxygenation were observed, as shown in FIG. 16C. EVLP was prolonged in the dialysis group with a mean duration of EVLP reaching 32±6.93 h in the EVLP+Dialysis group compared to 18.67±3.27 h in the historical control group (FIG. 16D). Percent lung survival at 24 h of perfusion was 100% in the E+D group, while only 20% was seen in historical controls (FIG. 16D). Two lungs which survived to 36 h of EVLP presented excellent lung function and excellent gross appearance (FIGS. 15A and 15B).

Thus, the study showed that dialysis may preserve lung function and length of EVLP by maintaining homeostasis of the lung.

Further details are provided in Example 5.

### Example 5

In the literature, other groups have tried to use EVLP perfusate containing whole blood (WB) or red blood cells (RBCs) or using a host animal to support a donor lung ex vivo through a cross-circulation between them. In a comparison of WB, RBCs and cross-circulation techniques, each has its own advantages and limitations such as listed in Table 2. According to various embodiments, hemodialysis and an enriched acellular EVLP perfusate were used to extend EVLP, using a machine to replace the need for a cross-circulation host (human or swine). These techniques aim to advance the clinical application of extended EVLP with relatively less ethical and technical challenges as other previously reported strategies.

TABLE 2
Comparing Toronto EVLP + Dialysis system with Cross-Circulation system.

| Strategies | Advantage | Disadvantage |
|---|---|---|
| Cross-circulation | Strong repair capacity | Ethical/technical difficulties |
| | | for clinical use |
| EVLP with fresh autologous | More physiological conditions | Technical challenges for fresh |
| whole blood/red blood | with repair capacity | blood, concerns on stored blood |
| cells | | |
| EVLP + Dialysis + newly | No need for a host to repair | Challenges to integrate dialysis |
| designed and enriched | donor lung, less challenges | with EVLP, and design and |
| perfusate | for fresh blood | select new perfusates |

According to various aspects, using hemodialysis to maintain homeostasis and using enriched perfusate to maintain physiological metabolism can safely extend EVLP of donor lungs to 36 h and beyond, which will enable advanced repair, reconditioning and regeneration prior to transplantation.

### Approaches and Methods

Maintain Lung Homeostasis During EVLP with Hemodialysis

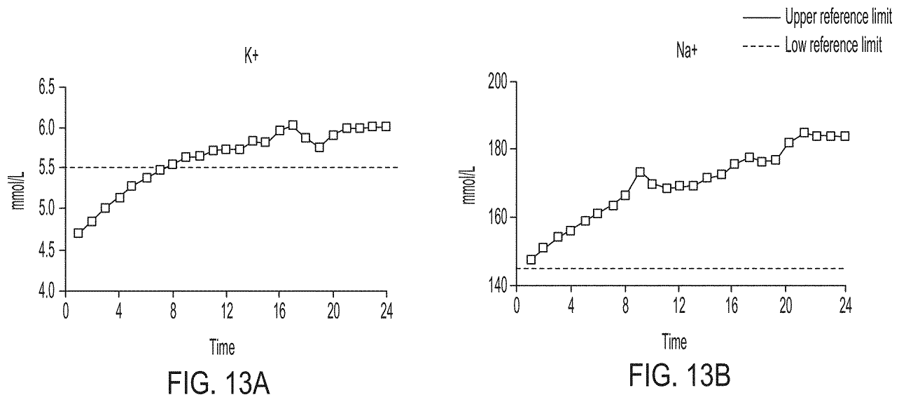

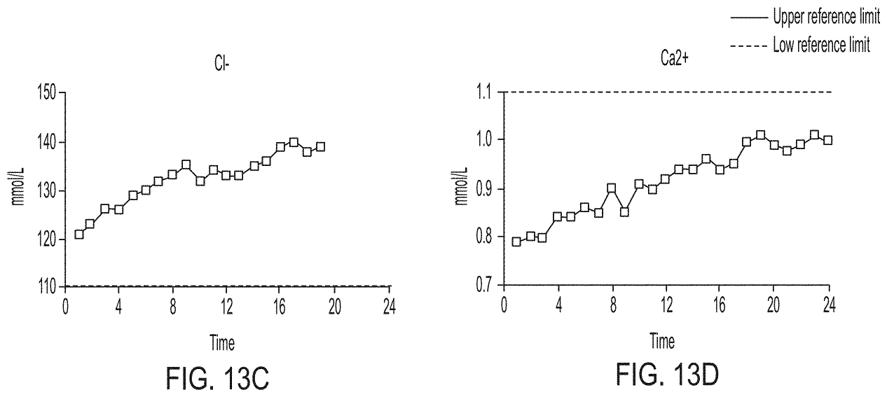

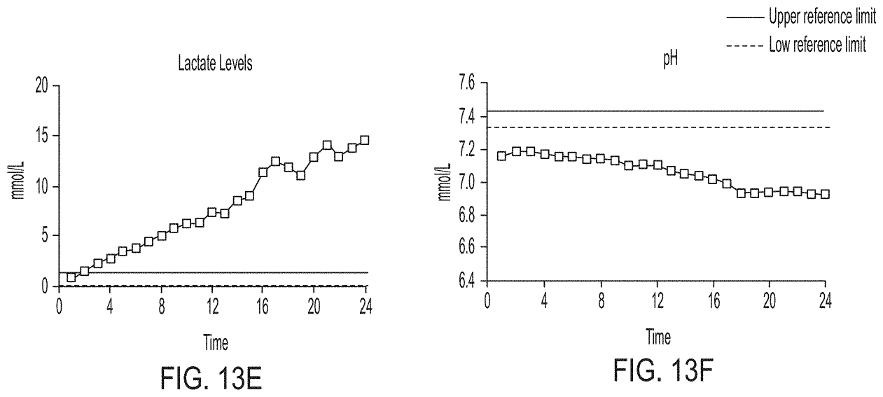

Rationale: The accumulation of electrolytes and metabolites in the EVLP perfusate (FIG. 13A-F and FIG. 3B, FIGS. 4A-4B) should be prevented, as they will negatively affect homeostasis of the lung tissue. Hemodialysis, according to some embodiments, uses an artificial semi-permeable membrane to balance water and molecules between blood and dialysate. As such, according to various embodiments, dialysis was used to maintain electrolyte and glucose levels between EVLP perfusate and a novel dialysate, to extend EVLP. With this combination, 30 h EVLP+dialysis was achieved in 4 out of 6 cases. FIG. 17 shows the experimental design used in this example.

### Optimize Hemodialysis Settings

Dialysis machine and hemodialysis modality: the Prismaflex system (Baxter International, Deerfield, Ill.) and HF 1400 CRRT set (Gambro, Mississauga, Canada) were used, employing continuous veno-venous hemofiltration dialysis—a form of hemodialysis based on a low flow rate. The access and return cannula of the dialyzer were changed from the pulmonary artery inlet side to the pulmonary vein outlet side. Dialysis settings (perfusate and dialysate flow rates) were optimized and dialysis solution components were changed.

Pig lungs were preserved at 4° C. followed by EVLP. These conditions result in ‘normal’ lungs; as such, any observed benefit or injury in this context is estimated to be the result of experimental settings.

Lung function assessment: Perfusate was sampled regularly. PO₂, PCO₂, pH, Na⁺, K⁺, Ca²⁺, Cl⁻, glucose and lactate were determined via a blood gas analyzer (see FIG. 17; Table 3). Pulmonary function was monitored continuously and assessed every hour, including static and dynamic compliances, peak airway inspiratory pressure, pulmonary artery pressure and pulmonary vascular resistance (PVR). Lung tissue biopsies were collected before, during and at the end of EVLP. Lung wet-to-dry ratio was measured as an indicator of lung edema.

TABLE 3
Experimental design: Sample collection during the experimentation.

| Sample | Preparation | Purpose |
|---|---|---|
| Tissue | Snap frozen in liquid N₂ | Cytokine analysis |
| (1 cm³) | Stored as −80° C. | ATP and Glutathione analysis |
| | | Metabolomics |
| Tissue | Stored in formalin | Histology |
| (1 cm³) | Transferred to alcohol | Special staining |
| | Embedded in paraffin | immunostaining |
| Perfusate | Snap frozen in liquid N₂ | Bacterial analysis |
| (4 mL - Raw) | Stored at −80° C. | Metabolomics |
| Perfusate | Spun at 400 G for 5 min at 4° C. | Cytokine analysis |
| (4 mL - Supernatant) | Supernatant extracted | P-selectin, M30, M65, |
| | Snap frozen, stored at −80° C. | HMGB1, NO, ET-1 |
| Perfusate | 0.6 mL freezing media added to cell pellet | |
| (1.2 mL - Cell Suspension) | Snap frozen, stored at −80° C. | |
| Dialysate Effluent | Snap frozen in liquid N₂ | Cytokine analysis |
| (4 mM - Raw) | Stored at −80° C. | Metabolomics |
| BAL | Spun at 3500 RPM for 10 min at 4° C. | Cytokine analysis |
| (4 mL - Supernatant) | Snap frozen, stored at −80° C. | P-selectin |

According to various aspects of the systems and methods described herein, EVLP has been extended to longer than 30 h in 4 out of 6 cases, and longer than 36 h in 2 of these cases. Gross appearance of one of pig lungs that reached 36 h EVLP is shown in FIG. 15A-B. In all 6 cases, dialysis prevented the accumulation of Na+, K+, Ca2+, Cl− in EVLP perfusate (FIG. 16A). No decrease in glucose and pH was observed, no increase in lactate was observed, and high PO₂ was maintained in 2 cases over 36 h (FIG. 16B), with higher static lung compliances, low airway pressure, and low PVR (FIG. 16C). 100% of dialysis cases were able to proceed to 24 hours compared to only 20% of historical controls, as demonstrated in FIGS. 16B-D.

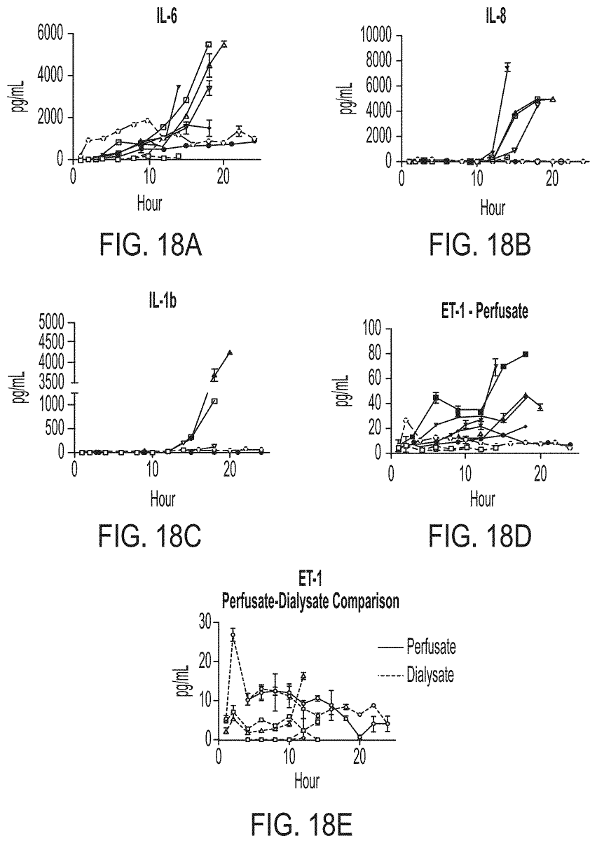

Dialysis helped to remove IL-6, IL-8 and IL-1β, in comparison with our historical samples (FIG. 18A-C). Dialysis may have similar effects on other inflammatory mediators.

Literature has shown that higher levels of ET-1 and big-ET-1 (an endothelium-derived contracting factor and its precursor) in human EVLP perfusate were associated with the development of PGD after lung transplantation. Advantageously, the removal of ET-1 from perfusate to dialysate was demonstrated as shown in FIG. 18D-E.

### Example 6

According to various embodiments, the improved perfusion solution comprising glutamine can be used with the improved method of ex-vivo lung perfusion comprising dialysis to extend ex-vivo lung perfusion from up to about 16 hours to up to about 36 hours.

### Example 7

### Methods for Metabolomics Studies

### Donor Lung Sample Selection

The EVLP perfusate was collected from 50 extended criteria human donor lungs, comprising of both donation after brain death (DBD) and donation after circulatory death (DCD), by the Toronto Lung Transplant Program between September 2008 and December 2011. All patients signed consent for biobanking donor lung perfusates.

### Toronto EVLP Protocol

The EVLP circuit was primed with 2 L of acellular Steen perfusate solution (XVIVO, Sweden). After commencing EVLP, the circuit was gradually warmed to 37° C. When the temperature reached 32° C., protective ventilation was started. Ten ml aliquots of perfusion fluid were withdrawn from the circuit after the first (EVLP-1 h) and fourth hours (EVLP-4 h) of perfusion. These samples were snap frozen and stored at −80° C. (FIG. 2A). After the first hour sample collection, 500 ml of the perfusate was removed and replaced with 500 ml of fresh Steen solution.

### Sample Preparation and Metabolic Profiling

A total of 100 human lung perfusate samples and two samples of blank Steen solution serving as control were sent to Metabolon Inc. (Durham, N.C.) for untargeted metabolic profiling. Samples for profiling analysis were extracted and prepared using Metabolon's standard solvent extraction method, using gas chromatography mass spectrometry (GC-MS) and liquid chromatography tandem mass spectrometry (LC-MS/MS) platforms. Data extraction, peak identification, compound identification and relative concentrations were provided by Metabolon Inc. Briefly, peaks were identified using Metabolon's proprietary peak integration software. Compounds were identified by comparisons to the metabolomic library of more than 1,000 commercially available purified standards, based on the combination of chromatographic properties and mass spectra.

### Data Quality Control and Metabolomics

Metabolites with less than 50% missing values were imputed with half the observed minimum value on the assumption that they were below the limit of detection. Those with greater than 50% of missing values were removed. The data was pre-treated by quantile normalization, logarithm transformation and auto-scaling. The data processing and statistical tests were conducted using MetaboAnalyst 4.0 web interface (https://www.metaboanalyst.ca/). Principal component analysis (PCA) was performed to test for the separability of the paired samples. Paired Student's t-tests were performed between the two sample collection time points to identify a list of significant metabolites. All p-values are two-sided, and the significance was set to false discovery rate (FDR) adjusted p-value to <0.05. The list was then filtered by a fold change (FC) of 1.1 or greater. The lenient FC-threshold was chosen to capture the global trend of all the metabolic changes in the donor lungs over the course of the perfusion. The biochemicals identified significant were then assigned to their broad class of compounds (amino acid, carbohydrate, lipid, nucleotide, peptide, cofactors and vitamin, and energy) as described by Kyoto Encyclopedia of Genes and Genomes (KEGG) and Human Metabolome Database (HMDB). Upon classification, they were individually mapped onto their major biochemical pathways to holistically visualize the metabolic shift. GraphPad Prism 8 (GraphPad Software, San Diego, Calif.) was used for graphical representation of results.

### Example 8

Exemplary Dialysate Components, Drug Doses and Regimens

DRUG DOSES + REGIMEN
Dialysis Priming Saline (2x NaCl 1 L)

| | | |
|---|---|---|
| Injectable | Concentration | Add: |

| Na⁺ | 140 | mmol/L | — | |
|---|---|---|---|---|
| K⁺ | 4 | mmol/K | 4 | ml |
| Ca²⁺ | 0.8 | mmol/L | 0.8 | ml |
| Glucose | 2 | g/L | 10 | mL |
| Heparin | 2500 | U/L | 6.67 | ml |
| Solumedrol | 0.5 | g/L | 2.67 | mL |
| Meropenem | 0.25 | g/L | 6.67 | mL |

Dialysate Bag (1x NaCl 5 L)

| | | |
|---|---|---|
| Injectable | Concentration | Add: |

| Na⁺ | 140 | mmol/L | — | |
|---|---|---|---|---|
| K⁺ | 4 | mmol/K | 20 | mL |
| Ca2⁺ | 0.8 | mmol/L | 4 | ml |
| Glucose | 2 | g/L | 50 | mL |
| Heparin | 2500 | U/L | 33.33 | mL |
| Solumedrol | 0.5 | g/L | 13.33 | mL |
| Meropenem | 0.25 | g/L | 33.33 | mL |
| Levofloxacin | 0.5 | g/L | 1.67 | g |

For Harvest

| | |
|---|---|
| Meropenem (500 mg) | 10 mL |
| Solumedrol (500 mg) | 4 mL |
| Heparin (10 000 U) | 10 mL |
| PGE1 (500 ug) | Whole bottle |

Flush (4x Perfadex 1 L)

| Bags 1&2: | Bags 3&4: |
|---|---|
| 0.3 mL THAM | 0.3 mL THAM |
| 0.6 mL CaCl₂ | 0.6 mL CaCl₂ |
| 250 ug (5 mL) PGE1 | |

EVLP Reservoir (1.5 L)

| | |
|---|---|
| Meropenem (500 mg) | 10 mL |
| Solumedrol (500 mg) | 4 mL |
| Heparin (10 000 U) | 10 mL |
| Levofloxacin (500 mg) | |

Replacement Steen (500 mL)

| | |
|---|---|
| Heparin (2500 mL) | 3.33 mL |
| Meropenem (125 mg) | 3.33 mL |
| Solumedrol (125 mg) | 1.33 mL |

### Embodiments

Below is a list of embodiments, according to various aspects of the system and methods described herein. It should be understood that any of the embodiments below can be combined with any other embodiment without departing from the principles described herein.

Embodiment 1: A perfusion solution comprising: a colloid component, a salt mixture, a buffer system, and a glutamine compound in a physiologically acceptable medium.

Embodiment 2: The organ perfusion solution of embodiment 1, wherein the glutamine compound is a stabilized glutamine compound.

Embodiment 3: The organ perfusion solution of embodiment 1 or 2, wherein the stabilized glutamine compound is a dipeptide comprising glutamine.

Embodiment 4: The organ perfusion solution of any one of embodiments 1 to 3, wherein the dipeptide comprising glutamine is L-alanyl-L-glutamine.

Embodiment 5: The organ perfusion solution of any one of embodiments 1 to 4, wherein the concentration of the glutamine compound provides a minimum concentration of glutamine of at least 0.5 mM.

Embodiment 6: The organ perfusion solution of any one of embodiments 1 to 4, wherein the concentration of the glutamine compound provides a minimum concentration of glutamine of at least 1 mM, at least 2 mM, at least 3 mM, at least 4 mM up to 20 mM.

Embodiment 7: The organ perfusion solution of any one of embodiments 1 to 6, wherein the colloid component comprises dextran, optionally dextran 40.

Embodiment 8: The organ perfusion solution of any one of embodiments 1 to 7, wherein the salt mixture comprises one or more of NaCl, KCl, CaCl2 and MgCl2.

Embodiment 9: The organ perfusion solution of any one of embodiments 1 to 8, wherein the buffer system is selected from a phosphate buffer, a bicarbonate buffer, a histidine buffer or combinations thereof.

Embodiment 10: The organ perfusion solution of any one of embodiments 1 to 9, further comprising glucose, optionally D-glucose or glucose monohydrate, mannose and/or fructose.

Embodiment 11: The organ perfusion solution of any one of embodiments 1 to 10, further comprising albumin.

Embodiment 12: The organ perfusion solution of any one of embodiments 1 to 11, further comprising one or more of a sulphate, such as magnesium sulphate, antibiotics or antifungals such as cefazolin, ciprofloxacin, levofloxacin, meropenem or voriconazole, a corticosteroid such as methylprednisolone, one or more vitamins, additional amino acids, insulin, a vasodilator such as milrinone, a nitrate such as nitroglycerin, and dextrose.

Embodiment 13: The organ perfusion solution of any one of embodiments 1 to 12, wherein the osmolarity of the solution is 280 to 380 mOsm/L.

Embodiment 14A: The organ perfusion solution of any one of embodiments 1 to 13, wherein the organ perfusion solution is acellular.

Embodiment 14B: The organ perfusion solution of any one of embodiments 1 to 13, wherein the organ perfusion solution comprises RBCs.

Embodiment 15: An organ perfusion kit comprising a container comprising containing a glutamine compound; a container comprising containing an organ perfusion solution, the organ perfusion solution comprising a colloid component and a salt mixture in a physiologically acceptable medium.

Embodiment 16: The organ perfusion kit of embodiment 15, wherein the glutamine compound is as defined in any one of embodiments 1 to 14.

Embodiment 17: The organ perfusion kit of any one of embodiments 15 or 16, wherein the glutamine compound is provided as a powder for reconstitution.

Embodiment 18: The organ perfusion kit of any one of embodiments 15 to 17, wherein the colloid component, the salt mixture and the physiologically acceptable medium is as defined in any one of embodiments 1 to 14.

Embodiment 19: The organ perfusion kit of any one of embodiments 15 to 18, wherein the organ perfusion solution further comprises one of the components listed in any one of embodiments 10-12 or has the osmolarity as defined in embodiment 13.

Embodiment 20: The organ perfusion kit of any one of embodiments 15 to 19, wherein the organ perfusion solution is acellular.

Embodiment 21: The organ perfusion kit of any one of embodiments 15 to 20, wherein each container is sterile.

Embodiment 22: An organ perfusion system comprising an organ perfusion device the organ perfusion device comprising an inlet for connecting to the organ via an input vessel of the organ, (PA) an outlet for connection to the organ via an output vessel of the organ, (LA) a perfusion circuit comprising: a reservoir for holding organ perfusion solution: a waste receptacle; and a plurality of fluid conduits defining a delivery fluid path connecting the reservoir with the inlet (into the PA); a return fluid path independent of the delivery fluid path connecting the outlet with the reservoir (from LA); a dialysis fluid diversion path; and a dialysis fluid return path; and an integrated continuous fluid dialysis machine, the dialysis machine comprising a dialyzer unit, the dialyzer unit having a dialysate container for holding dialysate, a waste container for holding waste dialysate, a dialyzer with: a perfusion import port for receiving fluid to be dialyzed and for connecting to the conduit defining the fluid diversion path, a perfusion export port for returning fluid that has been dialyzed and for connecting to the conduit defining the fluid return path to the export port of the dialyzer, a dialysate import port fluidly connected to the dialysate container; and a dialysate export port fluidly connected to the waste container; and a dialysis filter cartridge; wherein, optionally, the system is configured to permit a flow rate of about 0.1 L to about 3 L through the perfusion circuit and the organ, about 50-200 ml/minute, preferably about 100 ml/minute through the dialysis flow path and the dialyzer and the dialysis machine is configured to permit dialysate to flow at a flow rate of about 150-400 ml/hour, optionally about 300 ml/hour.

Embodiment 23: The organ perfusion system of embodiment 22, wherein the conduits that define the dialysis fluid diversion path and the dialysis fluid return path cannulate the conduit that defines the return fluid path connecting the outlet with the reservoir.

Embodiment 24: The organ perfusion system of any one of embodiments 22 or 23, wherein the dialysis filter cartridge is for dialyzing out molecules less than or about 30 kDa optionally less than or about 25 kDa.

Embodiment 25: The organ perfusion system of any one of embodiments 22 or 23, wherein the dialysis machine is configured to perform continuous veno-venous hemodialysis without filtration.

Embodiment 26: The organ perfusion system of any one of embodiments 22 to 24, wherein the dialysis filter cartridge comprises a polyarylethysulfone (PAES) membrane and is suitable for ultrafiltration of solutes with minimal protein absorption (HF 1400 CRRT set).

Embodiment 27: The organ perfusion system of any one of embodiments 22 to 26, further comprising a waste fluid path independent of the inlet, the outlet and the return fluid path, connecting the reservoir with the waste receptacle for directing the perfusion fluid from the reservoir to the waste receptacle without traversing the organ.

Embodiment 28: The organ perfusion system of any one of embodiments 22 to 27, further comprising an organ chamber for receiving the organ, a pump for pumping organ perfusion solution through the organ perfusion device and the dialysis machine, one or more flow meters, a blood cell filter such as a leukocyte filter for capturing blood cells flushed from the organ during perfusion, gas exchanger for deoxygenating the perfusion solution, a heater/heat exchanger, a ventilator when the organ is a lung or lungs and/or gas source for providing for example carbon dioxide to the perfusion solution.

Embodiment 29: A method for machine perfusion of an organ comprising: circulating an organ perfusion solution through the organ using an organ perfusion device; and continuously dialyzing a portion of the circulating organ perfusion solution with a dialysate using an integrated dialysis machine; optionally wherein the perfusion and/or the dialysis is performed for at least 4 hrs, or at least 8 hrs.

Embodiment 30: The method of embodiment, wherein the organ perfusion solution is the organ perfusion solution of any one of embodiments 1 to 14.

Embodiment 31: The method of any one of embodiment 29 or 30, wherein a reservoir holds the perfusion organ solution that is circulated, and the organ perfusion solution is replenished after a set period of time.

Embodiment 32: The method of any one of embodiments 29 to 31, wherein the dialysate comprises a salt solution (e.g., Na+ 140 mmol/L, K+ 4 mmol/L, Ca2+ 0.8 mmol/L).

Embodiment 33: The method of any one of embodiments 29 to 32, wherein the dialysis machine is configured for continuous veno-venous hemodialysis without filtration.

Embodiment 34: The method of any one of embodiments 29 to 33, wherein the organ perfusion device and the integrated dialysis machine are part of an organ perfusion system.

Embodiment 35: The method of any one of embodiments 29 to 34, wherein the organ perfusion system is a system of embodiments 22 to 28.

Embodiment 36: The method of any one of embodiments 29 to 35, wherein the system is configured to permit a flow rate of about 0.1 L to about 3 L through the perfusion circuit and the organ, about 50-200 ml/minute, preferably 100 ml/minute through the dialysis flow path and the dialyzer, and the dialysis machine is configured to permit dialysate to have a flow rate of about 150-400 ml/hour, optionally about 300 ml/hour.

Embodiment 37: The method of any one of embodiments 29 to 36, wherein the organ perfusion solution comprises an antimicrobial cocktail, a corticosteroid such as methylprednisolone (solumedrol), and/or an anticoagulant such as heparin.

Embodiment 38: The method of any one of embodiments 29 to 37, wherein the dialysate comprises an antimicrobial cocktail, a corticosteroid such as methylprednisolone (solumedrol), and/or an anticoagulant such as heparin.

Embodiment 39: The method of any one of embodiments 37 or 38, wherein the antimicrobial cocktail comprises one or more of cefazolin, ciprofloxacin, levofloxacin, meropenem or voriconazole.

Embodiment 40: The method of 39, wherein the perfusion solution further comprises whole blood or a blood cell fraction such as red blood cells or serum.

Embodiment 41: The method of any one of embodiments 29 to 40, wherein the organ perfusion device comprises a reservoir comprising the organ perfusion solution.

Embodiment 42: The method of any one of embodiments 29 to 41, wherein the circulating the organ perfusion solution and the dialyzing is performed for at least or about 4 hours, 6 hours, 8 hours, 10 hours, 12 hours, 14 hours, 16 hours, 18 hours, 20 hours, 22 hours, 24 hours, 26 hours, 28 hours, 30 hours, 32 hours, 34 hours, or 36 hours or longer.

Embodiment 43: A method for delivery of a therapeutic agent to an ex vivo organ for transplant comprising: obtaining the organ, the organ having preferably been flushed with a non-blood physiologic solution; introducing the organ into an organ perfusion device and integrated dialysis machine, the organ perfusion device comprising a reservoir comprising organ perfusion solution, the dialysis machine comprising a dialysate container comprising organ dialysate, the organ perfusion solution and optionally the organ dialysate comprising the therapeutic agent; circulating the organ perfusion solution comprising the therapeutic agent through the organ using the organ perfusion device; and dialyzing a portion of the organ perfusion solution as it circulates through the organ using the integrated dialysis machine.

Embodiment 44: The organ perfusion solution, the organ perfusion kit, the method or the organ perfusion system of any one of embodiments 1 to 43, wherein the organ perfusion solution, the organ perfusion kit, the method or the organ perfusion system is for extended ex vivo perfusion (EVP).

Embodiment 45: The organ perfusion solution, the organ perfusion kit, the method or the organ perfusion system of any one of embodiments 1 to 27, 29 to 39, and 41 to 43, wherein the organ is selected from liver, heart, kidney, pancreas or bowel.

Embodiment 46: The organ perfusion solution, the organ perfusion kit, the method or the organ perfusion system of any one of embodiments 1 to 43, wherein the organ is a lung.

Embodiment 47: A method of improving and/or repairing an ex vivo organ, said method comprising the steps of: (i) determining the status of the organ by evaluating pre-selected criteria; (ii) subjecting the organ to the organ perfusion system of any one of embodiments 22 to 28 for a period of time; and (iii) determining improvement of the organ by re-evaluating the pre-selected criteria.

Embodiment 48: The method of embodiment 47, wherein the organ is a lung, liver, heart, kidney, or pancreas.

Embodiment 49: The method of any one of embodiments 47 or 48, wherein the ex vivo organ is a lung and the pre-selected criteria include dynamic compliance.

Embodiment 50: The method of embodiment 49, wherein the re-evaluated dynamic compliance is 15 ml/cmH₂O or higher.

Embodiment 51: The method any one of embodiments 47 to 50, wherein the period of time is at least 24 hours.

Embodiment 52: The method any one of embodiments 47 to 51, wherein the organ is a lung.

Embodiment 53: The method of embodiment 52, wherein the lung is a donation after circulatory death (DCD) or a donation after brain death (DBD).

Embodiment 54: The method of any one of embodiments 47 to 53, wherein step (ii) further comprises subjecting the organ to a therapeutic agent.

Embodiment 55: The method of any one of embodiment 54, wherein the therapeutic agent is delivered using the method of embodiment 43.

Embodiment 56: The method of any one of embodiments 47 to 55, wherein the organ is rendered suitable for transplantation into a human.

Embodiment 57: A repaired and/or improved organ suitable for transplantation in a human, wherein the repaired and/or improved organ was repaired and/or improved using the methods of any one of embodiments 47 to 56, wherein the organ had been assessed as being unsuitable for transplantation into a human before subjection to the organ perfusion system and was determined to be suitable for transplantation subjection to the organ perfusion system.

1. An organ perfusion solution comprising:
a colloid component,
a salt mixture,
a buffer system, and
a glutamine compound in a physiologically acceptable medium.

2. The organ perfusion solution of claim 1, wherein the glutamine compound is a stabilized glutamine compound.

3. The organ perfusion solution of claim 1, wherein the stabilized glutamine compound is a dipeptide comprising glutamine.

4. The organ perfusion solution of claim 1, wherein the dipeptide comprising glutamine is L-alanyl-L-glutamine.

5. The organ perfusion solution of claim 1, wherein the concentration of the glutamine compound provides a minimum concentration of glutamine of at least 0.5 mM.

6. The organ perfusion solution of claim 1, wherein the concentration of the glutamine compound provides a minimum concentration of glutamine of at least 1 mM.

7. The organ perfusion solution of claim 1, wherein the colloid component comprises dextran.

8. The organ perfusion solution of claim 1, wherein the salt mixture comprises one or more of NaCl, KCl, CaCl₂, and MgCl₂.

9. The organ perfusion solution of claim 1, wherein the buffer system is a phosphate buffer, a bicarbonate buffer, a histidine buffer, or combinations thereof.

10. The organ perfusion solution of claim 1, further comprising glucose.

11. The organ perfusion solution of claim 1, further comprising albumin.

12. The organ perfusion solution of claim 1, further comprising one or more of a sulphate, antibiotics, antifungals, a corticosteroid, one or more vitamins, additional amino acids, insulin, a vasodilator, a nitrate, and dextrose.

13. The organ perfusion solution of claim 1, wherein the osmolarity of the solution is 280 to 380 mOsm/L.

14. The organ perfusion solution of claim 1, wherein the organ perfusion solution is acellular.

15. An organ perfusion kit comprising
a container containing a glutamine compound;
a container containing an organ perfusion solution, the organ perfusion solution comprising a colloid component and a salt mixture in a physiologically acceptable medium.

16. The organ perfusion kit of claim 15, wherein the glutamine compound is a stabilized glutamine compound.

17. The organ perfusion kit of claim 15, wherein the glutamine compound is provided as a powder for reconstitution.

18. The organ perfusion kit of claim 15, wherein the colloid component comprises dextran, the salt mixture comprises one or more of NaCl, KCl, CaCl₂, and MgCl₂, and/or the physiologically acceptable medium is a buffer system that is a phosphate buffer, a bicarbonate buffer, a histidine buffer, or combinations thereof.

19. The organ perfusion kit of claim 15, wherein the organ perfusion solution further comprises at least one of a sulphate, antibiotics, antifungals, a corticosteroid, one or more vitamins, additional amino acids, insulin, a vasodilator, a nitrate, and dextrose, and/or has an osmolarity of 280 to 380 mOsm/L.

20. The organ perfusion kit of claim 15, wherein the organ perfusion solution is acellular.

21. The organ perfusion kit of claim 15, wherein each container is sterile.

22. An organ perfusion system comprising:
an organ perfusion apparatus for perfusing an organ with organ perfusion solution; and
an integrated continuous fluid dialysis machine that dialyzes at least a portion of the organ perfusion solution.

23. The organ perfusion system of claim 22, wherein the system is configured to permit a flow rate of about 0.1 L to about 3 L through the organ and about 50-200 ml/minute through the dialysis machine, and the dialysis machine is configured to permit dialysate to flow at a flow rate of about 150-400 ml/hour.

24. The organ perfusion system of claim 22, wherein the system comprises a dialysis fluid diversion path and a dialysis fluid return path, and the dialysis fluid diversion path and the dialysis fluid return path cannulate a conduit that defines a return fluid path connecting an outlet from the organ with the reservoir for the organ perfusion solution.

25. The organ perfusion system of claim 22, wherein the dialysis machine comprises a dialysis filter cartridge configured for dialyzing out molecules less than or about 30 kDa, optionally less than or about 25 kDa.

26. The organ perfusion system of claim 22, wherein the dialysis machine is configured to perform continuous veno-venous hemodialysis without filtration.

27. The organ perfusion system of claim 22, wherein the dialysis machine comprises a dialysis filter cartridge that comprises a polyarylethysulfone (PAES) membrane.

28. The organ perfusion system of claim 22, wherein the organ perfusion apparatus comprises an inlet for connecting to the organ via an input vessel of the organ, an outlet for connecting to an outlet vessel of the organ, and a return fluid path connecting the outlet with a reservoir for holding the organ perfusion solution, the system further comprising a waste fluid path independent of the inlet, the outlet, and the return fluid path, connecting the reservoir with a waste receptacle for directing the perfusion fluid from the reservoir to the waste receptacle without traversing the organ.

29. The organ perfusion system of claim 22, further comprising an organ chamber for holding the organ, a pump for pumping the organ perfusion solution through the organ perfusion apparatus and the dialysis machine, one or more flow meters, a blood cell filter for capturing blood cells flushed from the organ during perfusion, a gas exchanger for deoxygenating the perfusion solution, a heat exchanger, and a ventilator.

30. A method for machine perfusion of an organ comprising:
circulating an organ perfusion solution through the organ using an organ perfusion apparatus; and
continuously dialyzing at least a portion of the circulating organ perfusion solution with a dialysate using an integrated dialysis machine.

31. The method of claim 30, wherein the perfusion and/or the dialysis is performed for at least 4 hrs.

32. The method of claim 30, wherein the organ perfusion solution comprises a colloid component, a salt mixture, a buffer system, and a glutamine compound in a physiologically acceptable medium.

33. The method of claim 30, wherein a reservoir holds the organ perfusion solution that is circulated, and the organ perfusion solution is replenished after a set period of time.

34. The method of claim 30, wherein the dialysate comprises a salt solution.

35. The method of claim 30, wherein the dialysis machine is configured for continuous veno-venous hemodialysis without filtration.

36. The method of claim 30, wherein the organ perfusion apparatus and the integrated dialysis machine are components of an organ perfusion system.

37. (canceled)

38. The method of claim 36, wherein the system is configured to permit a flow rate of about 0.1 L/min to about 3 L/min through the organ, about 50-200 ml/minute through the dialysis machine, and the dialysis machine is configured to permit dialysate to have a flow rate of about 150-400 ml/hour.

39. The method of claim 30, wherein at least one of the organ perfusion solution and the dialysate comprise an antimicrobial cocktail, a corticosteroid, and/or an anticoagulant.

40. (canceled)

41. The method of claim 39, wherein the antimicrobial cocktail comprises one or more of cefazolin, ciprofloxacin, levofloxacin, meropenem, and voriconazole.

42. The method of 39, wherein the perfusion solution further comprises whole blood or a blood cell fraction.

43. The method of claim 30, wherein the organ perfusion device comprises a reservoir that contains the organ perfusion solution.

44. The method of claim 30, wherein the circulating the organ perfusion solution and the dialyzing is performed for at least or about 4 hours.

45. A method for delivery of a therapeutic agent to an ex vivo organ for transplant comprising:
obtaining the organ;
introducing the organ into an organ perfusion system that comprises an organ perfusion apparatus and an integrated dialysis machine;
circulating an organ perfusion solution comprising a therapeutic agent through the organ using the organ perfusion apparatus; and
dialyzing at least a portion of the organ perfusion solution using the integrated dialysis machine.

46. The method of claim 30, wherein the organ is a liver, a heart, a kidney, a pancreas or a bowel.

47. The method of claim 30, wherein the organ is a lung.

48. A method of improving and/or repairing an ex vivo organ, said method comprising:
(i) determining the status of the organ by evaluating pre-selected criteria;
(ii) perfusing the organ via an organ perfusion system that comprises: an organ perfusion apparatus for perfusing the organ with organ perfusion solution, and an integrated continuous fluid dialysis machine that dialyzes at least a portion of the organ perfusion solution; and
(iii) determining improvement of the organ by re-evaluating the pre-selected criteria.

49. The method of claim 48, wherein the organ is a lung, liver, heart, kidney, or pancreas.

50. The method of claim 48, wherein the ex vivo organ is a lung, and the pre-selected criteria include dynamic compliance.

51. The method of claim 50, wherein the re-evaluated dynamic compliance is 15 ml/cmH₂O or higher.

52. The method of claim 48, wherein the period of time is at least 24 hours.

53. The method of claim 48, wherein the organ is a lung.

54. The method of claim 53, wherein the lung is a donation after circulatory death (DCD) lung.

55. The method of claim 48, wherein step (ii) further comprises subjecting the organ to a therapeutic agent.

56. The method of claim 55, wherein the organ perfusion solution comprises the therapeutic agent is delivered.

57. The method of claim 48, wherein the organ is rendered suitable for transplantation into a human.

58. A repaired and/or improved organ suitable for transplantation in a human, wherein the repaired and/or improved organ was repaired and/or improved by:
(i) determining a status of the organ by evaluating pre-selected criteria;
(ii) perfusing the organ via an organ perfusion system that comprises: an organ perfusion apparatus for perfusing the organ with organ perfusion solution, and an integrated continuous fluid dialysis machine that dialyzes at least a portion of the organ perfusion solution; and
(iii) determining improvement of the organ bv re-evaluating the pre-selected criteria,
wherein the organ had been assessed as being unsuitable for transplantation into a human before being repaired and/or improved and was determined to be suitable for transplantation due to being repaired and/or improved.
